(19) United States
(12) Patent Application Publication
(10) Pub. No.: US 2023/0169707 A1
(43) Pub. Date: Jun. 1, 2023

(54) FEATURE LOCATION TECHNIQUES FOR RETINA FUNDUS IMAGES AND/OR MEASUREMENTS

(71) Applicant: Tesseract Health, Inc., Guilford, CT (US)

(72) Inventors: Muhamed Veysi Yildiz, Roslindale, MA (US); Tyler S. Ralston, Clinton, CT (US); Maurizio Arienzo, New York, NY (US)

(73) Assignee: Person to whom the inventor is obligated to assign, Guilford, CT (US)

(21) Appl. No.: 18/072,665

(22) Filed: Nov. 30, 2022

Related U.S. Application Data
(60) Provisional application No. 63/284,791, filed on Dec. 1, 2021.

(51) Int. Cl. G06T 11/20

(52) U.S. Cl. CPC G06T 11/206; G06T 2210/41

(57) ABSTRACT

Described herein are techniques for imaging and/or measuring a subject's eye, including the subject's retina fundus. In some embodiments, one or more processors may be used to generate a graph from an image and/or measurement (e.g., an optical coherence tomography image and/or measurement), which can be useful for locating features in the image and/or measurement. For example, the image and/or measurement can include a subject's retina fundus and the features may include one or more layers and/or boundaries between layers of the subject's retina fundus in the image and/or measurement.

### CROSS REFERENCE TO RELATED APPLICATIONS

This application claims the benefit of priority under 35 U.S.C. § 119(e) to U.S. Provisional Application Ser. No. 63/284,791, titled “FEATURE LOCATION TECHNIQUES FOR RETINA FUNDUS IMAGES AND/OR MEASUREMENTS,” and filed on Dec. 1, 2021, the entire contents of which are incorporated by reference herein.

### FIELD OF THE DISCLOSURE

The present disclosure relates to techniques for imaging and/or measuring a subject's eye, including the subject's retina fundus.

### BACKGROUND

Techniques for imaging and/or measuring a subject's eye would benefit from improvement.

### SUMMARY OF THE DISCLOSURE

Some aspects of the present disclosure relate to a method generating a graph from an image and/or measurement of a subject's retina fundus, wherein generating the graph comprises generating, by at least one processor a plurality of nodes corresponding to a plurality of pixels of the image and/or measurement and a plurality of edges connecting the plurality of nodes, at least one auxiliary node, and an auxiliary edge connecting the auxiliary node to a first node of the plurality of nodes.

In some embodiments, the auxiliary edge is a first auxiliary edge, generating the graph further comprises, by the at least one processor, generating a second auxiliary edge connecting the at least one auxiliary node to a second node of the plurality of nodes, and the first and second nodes correspond to respective first and second pixels in a first column of the image and/or measurement.

In some embodiments, the at least one auxiliary node comprises a first auxiliary node, which is a start node of the graph, and a second auxiliary node, which is an end node of the graph.

In some embodiments, the auxiliary edge is a first auxiliary edge and the first node corresponds to a first pixel of the plurality of pixels in a first column of the image and/or measurement, generating the graph further comprises, by the at least one processor, generating a second auxiliary edge connecting the first auxiliary node to a second node of the plurality of nodes corresponding to a second pixel of the plurality of pixels in the first column, a third auxiliary edge connecting the second auxiliary node to a third node of the plurality of nodes corresponding to a third pixel of the plurality of pixels in a second column of the image and/or measurement, and a fourth auxiliary edge connecting the second auxiliary node to a fourth node of the plurality of nodes corresponding to a fourth pixel of the plurality of pixels in the second column.

In some embodiments, the method may further comprise locating, by the at least one processor, a boundary between first and second layers of the subject's retina fundus in the image and/or measurement using the graph.

In some embodiments, the at least one auxiliary node comprises a start node and/or an end node of the graph and locating the boundary comprises determining a plurality of paths from the start node to the at least one auxiliary node and/or from the at least one auxiliary node to the end node and selecting a path from among the plurality of paths.

In some embodiments, generating the graph further comprises assigning, to at least some of the plurality of nodes and/or edges, weighted values; generating the auxiliary edge comprises assigning, to the auxiliary node and/or edge, a preset weighted value; and selecting the path from among the plurality of paths comprises executing a cost function using the weighted values and the preset weighted value and determining that the path has and/or shares a lowest cost among the plurality of paths.

In some embodiments, the weighted values are assigned to the plurality of nodes based on pixel intensity of pixels corresponding to the plurality of nodes and/or assigned to the plurality of edges based on pixel intensity of pixels that correspond to pairs of the plurality of nodes connected by the plurality of edges.

In some embodiments, the weighted values are assigned to the plurality of nodes based on frequency and/or phase of pixels corresponding to the plurality of nodes and/or assigned to the plurality of edges based on frequency and/or phase of pixels that correspond to pairs of the plurality of nodes connected by the plurality of edges.

In some embodiments, executing the cost function comprises determining a cost for each of the plurality of paths, the cost of each path being based at least in part on of the weighted values and/or preset weighted value assigned to nodes and/or edges in each path.

In some embodiments, the preset weighted value has a minimum cost.

Some aspects of the present disclosure relate to a method comprising generating a graph from an image and/or measurement of a subject's retina fundus, wherein generating the graph comprises, by at least one processor generating a plurality of nodes corresponding to a plurality of pixels of the image and/or measurement and a plurality of edges connecting the plurality of nodes selecting a start node and/or an end node of the graph from the plurality of nodes, and generating, connecting the start and/or end node to a first node of the plurality of nodes, at least one auxiliary edge.

In some embodiments, the method may further comprise, by the at least one processor, assigning weighted values to at least some of the plurality of nodes and/or plurality of edges and assigning a preset weighted value to the at least one auxiliary edge and/or start node and/or end node.

In some embodiments, the weighted values are assigned to the plurality of nodes based on pixel intensity of pixels corresponding to the plurality of nodes and/or assigned to the plurality of edges based on pixel intensity of pixels that correspond to pairs of the plurality of nodes connected by the plurality of edges.

In some embodiments, the weighted values are assigned to the plurality of nodes based on derivatives corresponding to the plurality of nodes and/or assigned to the plurality of edges based on derivatives of pixels that correspond to pairs of the plurality of nodes connected by the plurality of edges.

In some embodiments, the start node is selected to correspond to a first corner pixel of the image and/or measurement and the end node is selected to correspond to a second corner pixel of the image and/or measurement, and wherein the first and second corner pixels are in different columns of the image and/or measurement.

In some embodiments, generating the at least one auxiliary edge comprises generating a first plurality of auxiliary edges connecting the start node to respective ones of a first plurality of perimeter nodes of the plurality of nodes that correspond to pixels of a first column of pixels of the image and/or measurement, and generating a second plurality of auxiliary edges connecting the end node to respective ones of a second plurality of perimeter nodes of the plurality of nodes correspond to pixels of a second column of pixels of the image and/or measurement.

In some embodiments, the method may further comprise locating, by the at least one processor, a boundary between first and second layers of the subject's retina fundus in the image and/or measurement using the graph.

In some embodiments, locating the boundary comprises determining a plurality of paths from the start node to the end node via the auxiliary edge and selecting a path from among the plurality of paths.

In some embodiments, selecting the path comprises executing a cost function based on the weighted values and the preset weighted value and determining that the path has and/or shares a lowest cost among the plurality of paths.

In some embodiments, the preset weighted value has a minimum cost.

In some embodiments, executing a cost function comprises minimizing the cost function.

The foregoing summary is not intended to be limiting. Moreover, in accordance with various embodiments, aspects of the present disclosure may be implemented alone or in combination with other aspects.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a cloud-connected system for processing an image, in accordance with some embodiments of the technology described herein.

FIG. 2 is an example image including pixels, according to some embodiments.

FIG. 3 is an example graph including nodes corresponding to the pixels of the image of FIG. 2 and edges connecting the nodes, according to some embodiments.

FIG. 4A is an example graph including nodes corresponding to pixels of the image of FIG. 2, a pair of auxiliary nodes, and edges connecting the nodes of the graph, according to some embodiments.

FIG. 4B is the graph of FIG. 4A with an indicated path traversing the graph, according to some embodiments.

FIG. 5A is an alternative example graph including nodes corresponding to pixels of the image of FIG. 2 and edges connecting the nodes, according to some embodiments.

FIG. 5B is the graph of FIG. 5A with an indicated path traversing a portion of the graph, according to some embodiments.

FIG. 6A is the example image of FIG. 2 with a path traversing a portion of the image, according to some embodiments.

FIG. 6B is the example image of FIG. 2 with first and second subsets of pixels indicated in the image, according to some embodiments.

FIG. 6C is the example image of FIG. 2 with a second path further traversing a portion of the image, according to some embodiments.

FIG. 7 is an example image of a subject's retina fundus, according to some embodiments.

FIG. 8 is an example derivative image that may be generated using the image of FIG. 7, according to some embodiments.

FIG. 9 is another example image of a subject's retina fundus, according to some embodiments.

FIG. 10 is an example image that may be generated by shifting pixels within columns of the image of FIG. 9, according to some embodiments.

FIG. 11 is yet another example image of a subject's retina fundus, according to some embodiments.

FIG. 12 is an example positive derivative image of the image of FIG. 11, according to some embodiments.

FIG. 13 is the image of FIG. 11 with indicated paths traversing the internal limiting membrane (ILM) boundary and the inner segment-outer segment (IS-OS) boundary, respectively, of the subject's retina fundus, according to some embodiments.

FIG. 14 is an example negative derivative image of the image of FIG. 11, according to some embodiments.

FIG. 15 is the image of FIG. 11 with indicated paths traversing the ILM boundary, the IS-OS boundary, and the Bruch's Membrane (BM) boundary, respectively, of the subject's retina fundus, according to some embodiments.

FIG. 16 is the image of FIG. 11 indicating subsets of pixels having above a threshold pixel intensity level, according to some embodiments.

FIG. 17 is the image of FIG. 11 indicating one of the subsets of pixels indicated in FIG. 16, according to some embodiments.

FIG. 18 is the image of FIG. 11 indicating a subset of pixels corresponding to the retinal nerve fiber layer-ganglion cell layer (RNFL-GCL) boundary of the subject's retina fundus, according to some embodiments.

FIG. 19 is the image of FIG. 11 indicating subsets of pixels having below a threshold pixel intensity level, according to some embodiments.

FIG. 20 is an example positive derivative image of the image of FIG. 11 within the subsets of pixels indicated in FIG. 19, according to some embodiments.

FIG. 21 is the image of FIG. 11 with an indicated path traversing the inner nuclear layer-outer plexiform layer (INL-OPL) boundary of the subject's retina fundus, according to some embodiments.

FIG. 22 is an example negative derivative image of the image of FIG. 11 within the subsets of pixels indicated in FIG. 19, according to some embodiments.

FIG. 23 is the image of FIG. 11 with indicated paths traversing the inner plexiform layer-inner nuclear layer (IPL-INL) boundary and the outer plexiform layer-outer nuclear layer (OPL-ONL) boundary, respectively, of the subject's retina fundus, according to some embodiments.

FIG. 24 is a flowchart of an example method of generating a graph from an image and/or measurement, according to some embodiments.

FIG. 25 is a flowchart of an alternative example method of generating a graph from an image and/or measurement, according to some embodiments.

FIG. 26 is a flowchart of an example method of locating one or more features of a subject's retina fundus in an image and/or measurement of the subject's retina fundus, according to some embodiments.

### DETAILED DESCRIPTION

I. Introduction

The inventors have recognized and appreciated that a subject's (e.g., person's) eyes provide a window into the body that may be used to not only to determine whether the subject has an ocular disease, but to determine the general health of the subject. The retina fundus in particular can provide valuable information via imaging for use in various health determinations. However, conventional systems of imaging, measuring, and/or processing images and/or measurements of the fundus are limited in multiple respects.

The inventors recognized that conventional imaging and/or measurement systems do not accurately locate certain features of a subject's retina fundus in an image and/or measurement. For example, imaging and/or measurement systems do not accurately locate boundaries between retinal layers, let alone do so in a manner that is computationally efficient. In a clinical setting, when an image and/or measurement is captured, a clinician may have to inspect each image and/or measurement to locate features such as boundaries between retinal layers by segmentation in each image. In addition to being time consuming, this process is imperfect due to the practical limits of human eyesight, which can result in measurements that may be inaccurate. These measurements may be used to subsequently determine a health status of the subject, which may be inaccurate and/or incorrect. Similarly, existing systems for locating features of a subject's retina fundus in an image and/or measurement are not accurate or computationally efficient at doing so.

To solve the above problems, the inventors developed improved techniques and methods for generating, by one or more processors, a graph from an image and/or measurement (e.g., an optical coherence tomography image and/or measurement), which can be useful for locating features in the image and/or measurement. For example, the image and/or measurement can include a subject's retina fundus and the features may include one or more layers and/or boundaries between layers of the subject's retina fundus in the image and/or measurement.

In some embodiments, generating the graph may include generating nodes corresponding to pixels of the image and/or measurement and edges connecting the nodes. For example, nodes can be generated for some or all pixels of the image and/or measurement. In some embodiments, generating the graph may also include generating at least one auxiliary node. For example, the auxiliary node(s) can be generated in addition to the nodes of the graph that correspond pixels of the image and/or measurement, and can be a start node and/or end node of the graph. In some embodiments, generating the graph may also include generating an auxiliary edge connecting a first auxiliary node to a first node of the graph. For example, the auxiliary edge can be generated in addition to any edges generated that connect nodes of the graph corresponding to pixels.

The inventors recognized that generating the auxiliary node(s) and/or auxiliary edge(s) can increase computational efficiency of locating features using the graph. For example, feature location techniques described herein can include determining one or more paths traversing nodes and edges of the graph, and using the auxiliary node and/or edge can make selecting an appropriate path for feature location (e.g., using a cost function) more computationally efficient. In this example, using the auxiliary node and/or edge can more efficiently determine which node(s), corresponding to one or more pixels in the image and/or measurement, should be the second and/or next to last node(s) in the selected path.

In some embodiments, a first auxiliary node can be generated as a start node and a second auxiliary node can be generated as an end node. The inventors further recognized that path determination is more computationally efficient when the auxiliary node is a start or end node. In some embodiments, auxiliary edges can be generated connecting the auxiliary node(s) to some or all nodes corresponding to pixels in a same column of the graph, such as a perimeter column. For example, one of the nodes corresponding to pixels in a perimeter column may be the second or next to last node in a path that starts or ends at the perimeter column side of the image and/or measurement.

In some embodiments, weighted values can be assigned to nodes and/or edges of the graph and a preset weighted value, such as a minimum value, can be assigned to the auxiliary node(s) and/or edge(s). For example, locating a retina fundus feature using the graph can include executing a cost function based on the weighted values and/or preset weighted value. The inventors recognized that using preset weighted values, such as minimum values (e.g., local and/or global minima), can make selection of a path that indicates the location of the feature more computationally efficient.

In some examples, executing the cost function may include minimizing the cost function and selecting a path may include selecting a path of connected nodes and/or edges with a minimum cost. In some examples, (e.g., when inverted or negated cost functions are used) executing the cost function may include maximizing the cost function such that finding a path may include finding a path of connected nodes and edges with the maximum cost.

The inventors also recognized that generating one or more auxiliary edges can also make feature location using the generated graph more computationally efficient when the start and/or end node of the graph corresponds to a pixel in the image and/or measurement. According to other techniques described herein, in some embodiments, generating a graph can include generating nodes corresponding to pixels of an image and/or measurement and edges connecting the nodes, selecting a start and/or end node of the graph from among the nodes, and generating at least one auxiliary edge connecting the start and/or end node(s) to another node of the graph. For example, the start node and/or end node can be selected as a node corresponding to a corner pixel of the image and/or measurement. In this example, the auxiliary edge(s) can connect the corner pixel(s) to nodes corresponding to other pixels in the same column of the image and/or measurement, such as a perimeter column that includes the corner pixel. In some embodiments, the start node and end node can correspond to opposing corner pixels of the image and/or measurement.

Techniques described herein for locating retina fundus features in an image and/or measurement are more computationally efficient than previous techniques. For example, techniques described herein may require fewer edges when generating a graph for an image and/or measurement, which enhances efficiency of determining and/or selecting a path traversing the graph that corresponds to a feature.

The inventors have also developed other techniques described further herein that can be used alone or in combination with the above mentioned techniques to further increase the accuracy and computational efficiency of locating one or more features of a subject's retina fundus in an image and/or measurement. Such techniques can include, for example, first locating a first feature of the subject's retina fundus (e.g., a first retinal layer boundary) in an image and/or measurement and then using the location of the first feature to locate a second feature of the subject's retina fundus in the same image and/or measurement, in a derivative of the image and/or measurement, and/or in a subset of pixels of the image and/or measurement. The inventors recognized that, in some cases, the first and second features can have known juxtapositions (e.g., one is expected to be above the other, or vice versa) and/or relative pixel intensity levels in the image and/or measurement that can advantageously make locating the second feature more efficient and/or accurate after locating the first feature.

In some embodiments, techniques described herein can be performed using a system with at least one processor and memory that is configured to receive images and/or measurements over a communication network. Alternatively or additionally, in some embodiments, techniques described herein can be implemented onboard, and/or on images and/or measurements captured by an imaging and/or measuring apparatus. In some embodiments, imaging and/or measuring apparatuses described herein can be suitable for use by a subject with or without assistance from a provider, clinician, or technician. In some embodiments, the imaging and/or measuring apparatus and/or associated systems described herein can be configured to determine the subject's health status based on the captured images and/or measurements.

It should be appreciated that techniques described herein can be implemented alone or in combination with any other techniques described herein. In addition, at times, reference can be made herein only to images, but it should be appreciated that aspects described herein for images also apply to measurements, as embodiments described herein are not so limited.

II. Example Systems for Generating a Graph from an Image of a Retina

As described above, the inventors have developed techniques for generating a graph from an image of a retina. In some embodiments, such techniques may be implemented using example systems described herein. While reference is made below to images, it should be appreciated that aspects described herein for images also apply to measurements, as embodiments described herein are not so limited.

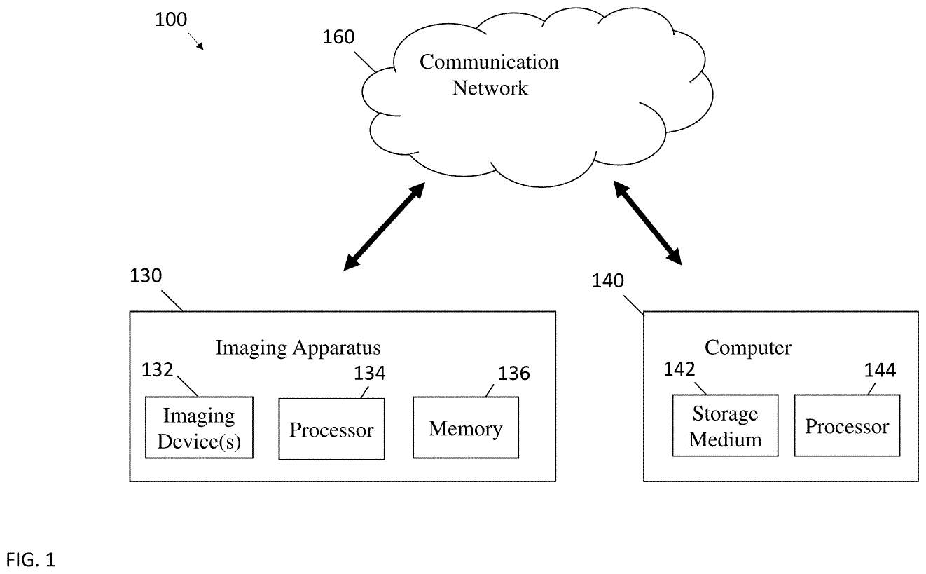

FIG. 1 is a block diagram of example system 100 for generating a graph from an image and/or measurement of a subject's retina, according to some embodiments. System 100 is shown in FIG. 1 including imaging apparatus 130 and computer 140, which may be coupled to one another over communication network 160. In some embodiments, imaging apparatus 130 may be configured to capture an image of a subject's retina and provide the image to computer 140 over communication network 160. In some embodiments, computer 140 may be configured to receive the image and generate the graph from the image. In some embodiments, imaging apparatus 130 may be alternatively or additionally configured to generate the graph from the image.

In some embodiments, imaging apparatus 130 may be configured to capture an image of a subject's retina and provide the image to computer 140 over communication network 160. As shown in FIG. 1, imaging apparatus 130 can include an imaging device 132, a processor 134, and a memory 136. In some embodiments, the imaging device 132 may be configured to capture images of a subject's eye, such as the subject's retina fundus. For example, in some embodiments, the imaging device 132 may include illumination source components configured to illuminate the subject's eye, sample components configured to focus and/or relay illumination light to the subject's eye, and detection components configured to capture light reflected and/or emitted from the subject's eye in response to the illumination. In some embodiments, imaging device 132 may include fixation components configured to display a fixation target on the subject's eye to guide the subject's eye to a desired position and/or orientation. According to various embodiments, the imaging device 132 could be an optical coherence tomography (OCT) device, a white light device, a fluorescence device, or an infrared (IR) device. In some embodiments, imaging apparatus 130 may include multiple imaging devices 132, such as any or each of the imaging devices described above, as embodiments described herein are not so limited.

In some embodiments, processor 134 may be alternatively or additionally configured to transmit captured images over communication network 160 to computer 140. In some embodiments, the imaging apparatus 130 may include a standalone network controller configured to communicate over communication network 160. Alternatively, the network controller may be integrated with processor 134. In some embodiments, imaging apparatus 130 may include one or more displays to provide information to a user of imaging apparatus 130 via a user interface displayed on the display(s). In some embodiments, imaging apparatus 130 may be portable. For example, imaging apparatus 130 may be configured to perform eye imaging using power stored in a rechargeable battery.

In some embodiments, computer 140 may be configured to obtain an image and/or measurement of a subject's retina fundus from imaging apparatus 130 and generate a graph from the image and/or measurement. For example. the computer 150 may be configured to use the graph to locate one or more features of the subject's retina fundus, such as a boundary between first and second layers of the subject's retina fundus. As shown in FIG. 1, computer 140 can include a storage medium 142 and processor 144.

In some embodiments, processor 144 can be configured to generate a graph from an image and/or measurement of a subject's retina fundus. For example, processor 144 can be configured to generate a plurality of nodes corresponding to a respective plurality of pixels of the image and/or measurement. In this example, the processor 144 can be configured to generate nodes for each pixel of the image and/or measurement or for only a subset of the image and/or measurement. In some embodiments, the processor 144 can be configured to generate a plurality of edges connecting the plurality of nodes. For example, once connected by edges, the processor 144 can be configured to traverse the nodes of the graph along the edges. In this example, the processor 144 can be configured to generate edges connecting each node or only a subset of the generated nodes.

In some embodiments, the processor 144 can be configured to generate an auxiliary node, as a start and/or end node of the graph, and a first edge from the auxiliary node to a second node of the graph. For example, the second node can be among the plurality of generated nodes that correspond to the pixels of the image and/or measurement, and the processor 144 can be configured to generate the auxiliary node in addition to the plurality of generated nodes that correspond to the pixels of the image and/or measurement. In some embodiments, the processor 144 can be configured to also generate a second edge from the start and/or end node to a third node of the graph. For example, the second and third nodes of the graph can be perimeter nodes corresponding to pixels along the perimeter of the image and/or measurement, such as in the same column of the image and/or measurement. Alternatively or additionally, in some embodiments, processor 144 can be configured to generate a graph from an image by selecting a start and/or end node from the nodes corresponding to the pixels of the image and/or measurement, with or without generating the auxiliary node. For example, processor 144 can be configured to generate an auxiliary edge connecting a start and/or end node to another node that corresponds to a pixel of the image and/or measurement.

In some embodiments, the processor 144 can be configured to locate at least one feature of the subject's retina fundus in the image and/or measurement using the graph. For example, the processor 144 can be configured to locate a boundary between first and second layers of the subject's retina fundus. In some embodiments, the processor 144 can be configured to determine a plurality of paths from the start node to the end node of the graph. For example, the processor 144 can be configured to traverse the graph from the start node to the end node via different paths that include one or more other nodes of the graph. In some embodiments, the processor 144 can be configured to assign a cost to each path based on a cost function. For example, the processor 144 can be configured to assign a cost based on derivatives of nodes included in the path (e.g., based on the difference of derivatives of the nodes). Alternatively or additionally, the processor 144 can be configured to assign a higher cost to longer paths (e.g., paths traversing more nodes than other paths). In some embodiments, the processor 144 can be configured to select a path from among the plurality of paths. For example, the processor 144 may be configured to select the path of the plurality of paths having and/or sharing a lowest cost.

In some embodiments, computer 140 may be further configured to pre-condition the image and/or measurement for locating the feature(s) of the subject's retina fundus. For example, in some embodiments, the processor 144 can be configured to generate a derivative of the image and/or measurement and generate the graph using the image and/or measurement derivative. For example, processor 144 of computer 140 may be configured to apply a filter to the image and/or measurement to generate the derivative prior to generating the graph. Alternatively or additionally, in some embodiments the processor 144 may be configured to shift pixels within a column of the image and/or measurement prior to generating the graph. For example, the processor 144 may be configured to shift the pixels such that one or more pixels that correspond to a feature of the image and/or measurement are aligned within at least one row of pixels (e.g., with the feature contained in only one or two rows of pixels). Further alternatively or additionally, the processor 144 may be configured to select a subset of pixels of the image and/or measurement in which to locate the feature(s) of the subject's retina fundus. For example, the processor 144 can be configured to apply a pixel characteristic threshold, such as a pixel intensity threshold, to the image and/or measurement and locate the feature(s) only in subsets of pixels that are above (or below) the threshold. Alternatively or additionally, processor 144 can be configured to select a subset of pixels in which to locate the feature(s) based on previously determined locations of one or more other features in the image and/or measurement.

In accordance with various embodiments, communication network 160 may be a local area network (LAN), a cell phone network, a Bluetooth network, the internet, or any other such network. For example, computer 140 may be positioned in a remote location relative to imaging apparatus 130, such as a separate room from imaging apparatus 130, and communication network 160 may be a LAN. In some embodiments, computer 140 may be located in a different geographical region from imaging apparatus 130 and may communicate over the internet.

It should be appreciated that, in accordance with various embodiments, multiple devices may be included in place of or in addition to imaging apparatus 130. For example, an intermediary device may be included in system 100 for communicating between imaging apparatus 130 and computer 140. Alternatively or additionally, multiple computers may be included in place of or in addition to computer 140 to perform various tasks herein attributed to computer 140.

It should also be appreciated that, in some embodiments, systems described herein may not include an imaging and/or measuring apparatus, as at least some techniques described herein may be performed using images and/or measurements obtained from other systems.

III. Example Techniques for Locating Retina Fundus Features in an Image

As described herein, the inventors have developed techniques for generating a graph from an image and/or measurement of a subject's retina fundus and locating one or more features of the subject's retina fundus using the generated graph. In some embodiments, techniques described herein can be implemented using the system of FIG. 1, such as using one or more processors of an imaging apparatus and/or computer.

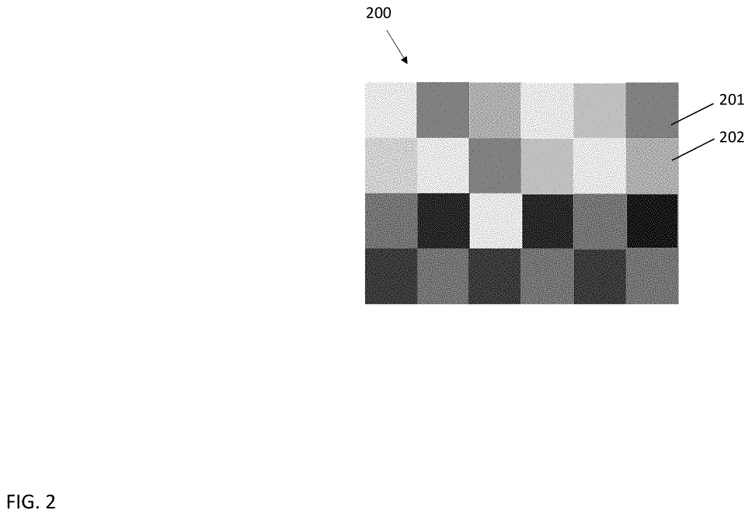

FIG. 2 is an example image 200 including a plurality of pixels, of which pixels 201 and 202 are labeled, according to some embodiments. In some embodiments, one or more processors of system 100, such as processor 134 of imaging apparatus 130 and/or processor 144 of computer 140 can be configured to generate a graph using image 200. In some embodiments, image 200 can be captured using an imaging device, such as imaging device 132 of imaging apparatus 130. For example, image 200 could be an OCT image, a white light image, a fluorescence image, or an IR image. In some embodiments, image 200 can include a subject's retina fundus. For example, one or more processors described herein may be configured to locate one or more features of the subject's retina fundus in image 200.

In some embodiments, pixels of image 200 can have pixel intensity values (e.g., ranging from 0 to 255), which can control the brightness of the pixels. For example, in FIG. 2, pixel 202 may have a lower pixel intensity value than pixel 201, as pixel 202 is shown having a higher brightness than pixel 201. In some embodiments, the pixel intensity values of pixels of image 200 may indicate the presence of one or more retina fundus features shown in the image 200. For example, pixel intensity values of a retina fundus image may correspond to the intensity of backscattered light received at the imaging device that captured the image 200, and the intensity of the backscattered light may vary depending on the features being imaged.

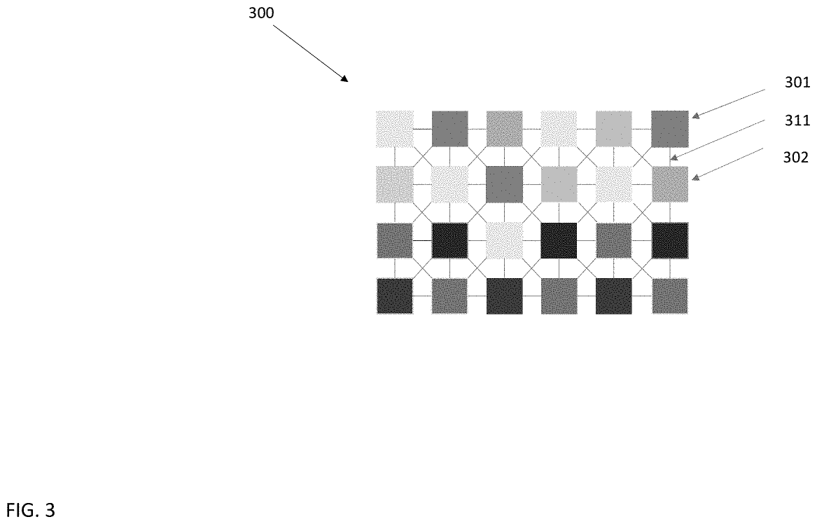

FIG. 3 is an example graph 300 including nodes corresponding to the pixels of image 200 and edges connecting the nodes, according to some embodiments. In some embodiments, one or more processors described herein may be configured to generate graph 300 using image 200, such as by generating nodes corresponding to some or all pixels of image 200. For example, in FIG. 3, node 301 of graph 300 can correspond to pixel 201 of image 200 and node 302 of graph 300 can correspond to pixel 202 of image 200. In some embodiments, the processor(s) may be further configured to generate edges connecting some or all nodes of graph 300. For example, in FIG. 3, edge 311 is shown connecting nodes 301 and 302. In some embodiments, the processor(s) may be configured to store the graph 300, including the nodes and edges, in a storage medium, such as storage medium 142 of computer 140.

In some embodiments, the processor(s) may be configured to store (e.g., in the storage medium) values associated with some or all nodes of graph 300, such as based on pixel intensity values of the pixels to which the nodes correspond. For example, the processor(s) may be configured to store, associated with node 301, the pixel intensity value of pixel 201. Alternatively or additionally, the processor(s) may be configured to store, associated with node 301, the derivative of the pixel intensity of image 200 at pixel 201. In either example, the processor(s) may be configured to use the stored values associated with each node to calculate costs associated with traversing one or more paths through the graph 300. Alternatively or additionally, in some embodiments, the processor(s) may be configured to store values associated with some or all edges of graph 300, such as based on the pixel intensity values of pixels corresponding to the nodes connected by the respective edge. For example, the processor(s) may be configured to store, associated with edge 311, a value that is based on the derivative of the pixel intensity of image 200 at each pixel 201 and 202. In this example, the processor(s) may be configured to use the stored values associated with each edge to calculate costs associated with traversing one or more paths through the graph 300.

In some embodiments, stored values associated with each node and/or edge connecting a pair of nodes may be weighted. In some examples, the stored values associated with each edge may be the calculated value of a cost function based on values of the nodes that form the edge. For example, the cost function may be 2−(gₐ+g_{b})+wₘᵢₙ, and the processor(s) may be configured to store, associated with edge 311, a weighted value w_{ab} equal to a value of the cost function 2−(gₐ+g_{b})+wₘᵢₙ, where gₐ, g_{b} are derivatives of pixel intensity at pixels a and b corresponding to nodes that are connected by the edge, and wₘᵢₙ may be a weight that is preset value. For instance, the preset value may be predetermined and/or calculated based on pixel intensity values of the image 200 rather than based on the particular pixel intensity values of the pixels corresponding to the two nodes connected by the edge. In this example, the preset value may be or may be less than the minimum value of all other edges.

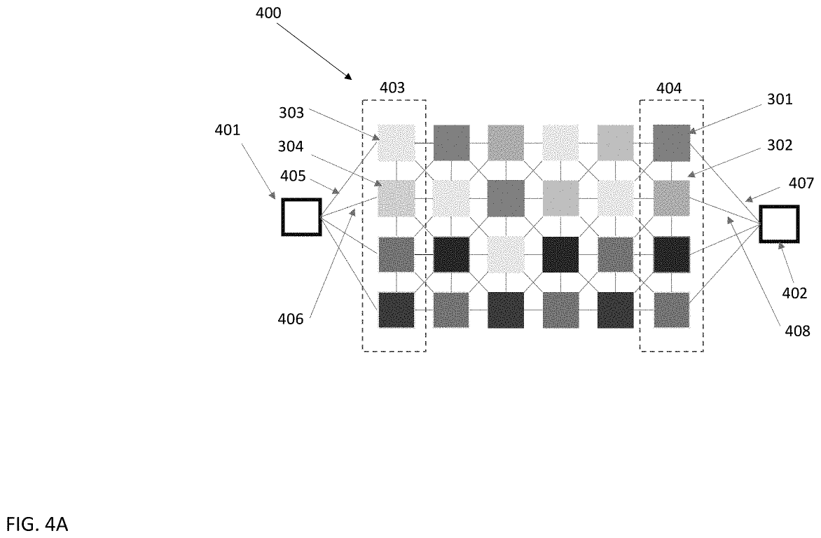

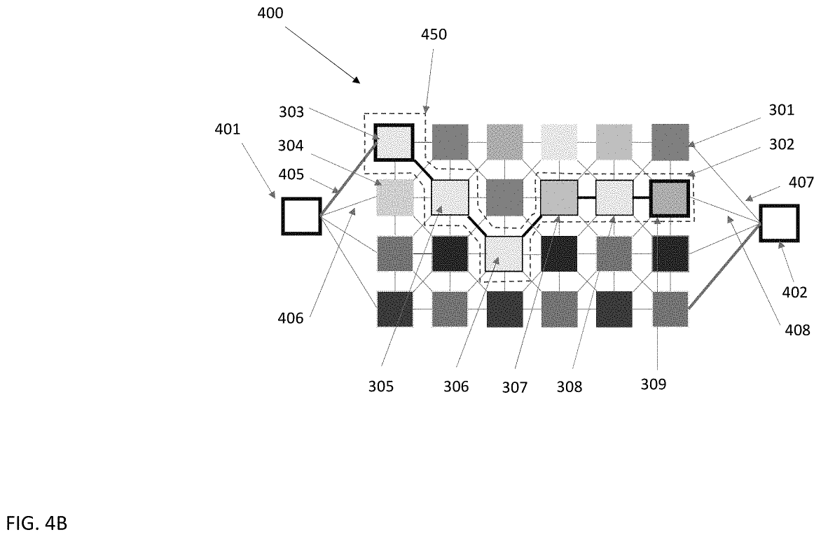

FIG. 4A is an example graph 400 including nodes corresponding to pixels of image 200, a pair of auxiliary nodes 401 and 402, and auxiliary edges connecting the auxiliary nodes to the nodes corresponding to image 200, according to some embodiments. In some embodiments, one or more processors described herein may be configured to generate graph 400 using graph 300 by generating auxiliary nodes 401 and 402 and edges connecting the auxiliary nodes 401 and 402 to at least some nodes on the perimeter of the graph. For example, as shown in FIG. 4A, auxiliary node 401 is connected to nodes 303 and 304 in perimeter column 403 of the graph via auxiliary edges 405 and 406, respectively, and auxiliary node 402 is connected to nodes 301 and 302 in perimeter column 404 of the graph via auxiliary edges 407 and 408, respectively.

In some embodiments, auxiliary node 401 and/or 402 may be start and/or end nodes of the graph 400. For example, the processor(s) may be configured to determine one or more paths traversing nodes and edges of graph 400 that start and/or end at auxiliary node 401 and/or 402. In some embodiments, the processor(s) may be configured to calculate a cost for each path, such as based on costs associated with each edge and/or node traversed by the path. For example, the costs associated with each edge and/or node may be based on the pixel intensity and/or derivative of pixel intensity at the respective edge and/or node, which can cause the lowest and/or highest cost paths to indicate the location(s) of one or more retina fundus features in the image 200. In some embodiments, the auxiliary edges connecting the auxiliary nodes 401 and/or 402 to other nodes of the graph 400 may be weighted with the same, preset value, such as the minimum value. For example, the minimum value may provide a minimum cost for traversing each auxiliary edge. According to various embodiments, the minimum cost can be a global minimum and/or a local minimum with respect to local nodes (e.g., corresponding to a particular subset of pixels).

FIG. 4B is graph 400 with an indicated path 450 traversing the graph 400, according to some embodiments. As shown in FIG. 4B, the indicated path 450 can traverse nodes 303, 305, 306, 307, 308, and 309 of graph 400. In some embodiments, one or more processors described herein may be configured to determine the path 450 by starting at auxiliary node 401 and/or 402 and traversing nodes of graph 400 until reaching the other of auxiliary nodes 401 and 402.

In some embodiments, the processor(s) may be configured to determine a plurality of paths traversing graph 400 and select path 450 from among the plurality of paths. For example, the processor(s) may be configured to calculate the cost of each path based on which nodes and/or edges are traversed by the respective path and determine that path 450 has and/or shares the minimum cost. In the example of FIG. 4B, the processor(s) may be configured to determine path 450 by starting at auxiliary node 401 and continuing to node 303 via auxiliary edge 405 (e.g., at minimum cost). From node 303, the processor(s) may be configured to determine that continuing from node 303 to node 305 has the lowest cost of all nodes that are connected to node 303 by a single edge, such as based on node 305 having the lowest pixel intensity value among all nodes that are connected to node 303 by a single edge. Similarly, the processor(s) may be configured to determine that continuing from node 305 to node 306 has the lowest cost of all nodes that are connected to node 305 by a single edge (e.g., excluding node 303). Once the processor(s) reach node 309, the processor(s) may be configured to determine that continuing to auxiliary node 402 via auxiliary edge 408 has the lowest cost of all nodes connected to node 309 by a single edge (e.g., as auxiliary edges connected to auxiliary nodes 401 and 402 may have the minimum cost). In some embodiments the processor(s) may be configured to select path 450 using an algorithm, such as Dijkstra's algorithm, Bellman-Ford, Floyd-Warshall, A*, and/or Johnson's algorithm.

FIG. 5A is an alternative example graph 500 including nodes corresponding to pixels of image 200 and edges connecting the nodes, according to some embodiments. In some embodiments, one or more processors described herein may be configured to generate graph 500 using graph 300, such as by selecting corner nodes 303 and 309 as start and/or end nodes of the graph 500 and generating auxiliary edges connecting node 303 to each node in perimeter column 403 and node 309 to each node in perimeter column 404. For example, the processor(s) may be configured to select corner node 303 and/or 309 as the start and/or end node for determining a plurality of paths traversing the graph 500 as described herein for graph 400. In FIG. 5A, auxiliary edge 505 is shown connecting node 309 to node 301 and auxiliary edge 506 is shown connecting node 309 to node 302. In some embodiments, the processor(s) may be configured to assign preset weighted values (e.g., minimum values) to auxiliary edges 505 and 506 as described herein for the auxiliary edges of graph 400.

It should be appreciated that any corner nodes of graph 300 may be selected as start and/or end nodes for determining the plurality of paths, according to various embodiments. In some embodiments, the processor(s) may be configured to determine one or more paths traversing graph 500 between nodes 303 and 309 in the manner described herein for graph 400.

FIG. 5B is the graph 500 with an indicated path 450 traversing a portion of the graph 500, according to some embodiments. As shown in FIG. 5B, the processor(s) may be configured to determine and/or select the same path 450 using nodes 303 and 309 as start and end nodes as in the example of FIGS. 4A-4B with auxiliary start and end nodes. In the illustrated example, the processor(s) may be configured to select path 450 based on determining that traversing other nodes in column 403 (FIG. 5A) connected to node 303, via auxiliary edges having preset values, exceeds the cost of traversing path 450. For other example images, the processor(s) may be configured to select a path that traverses one or more auxiliary edges from node 303 to a node in column 403.

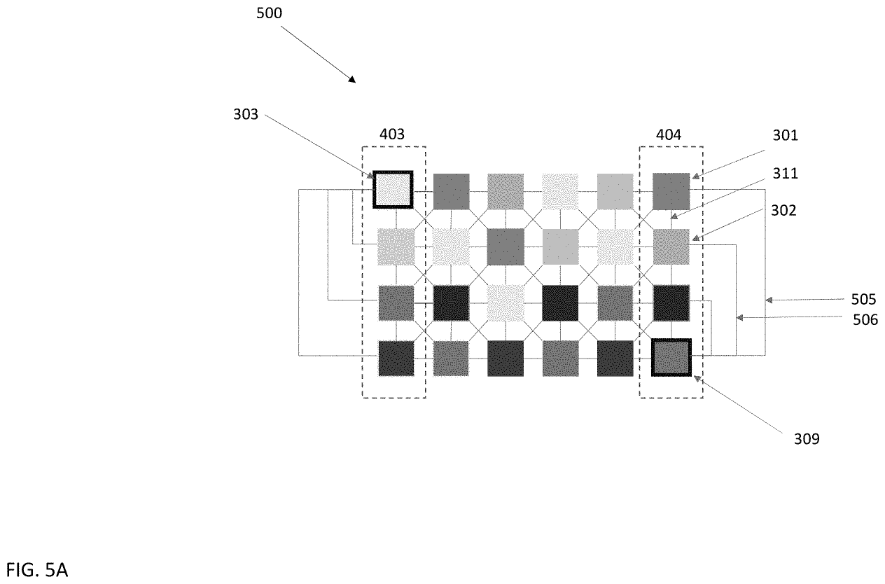

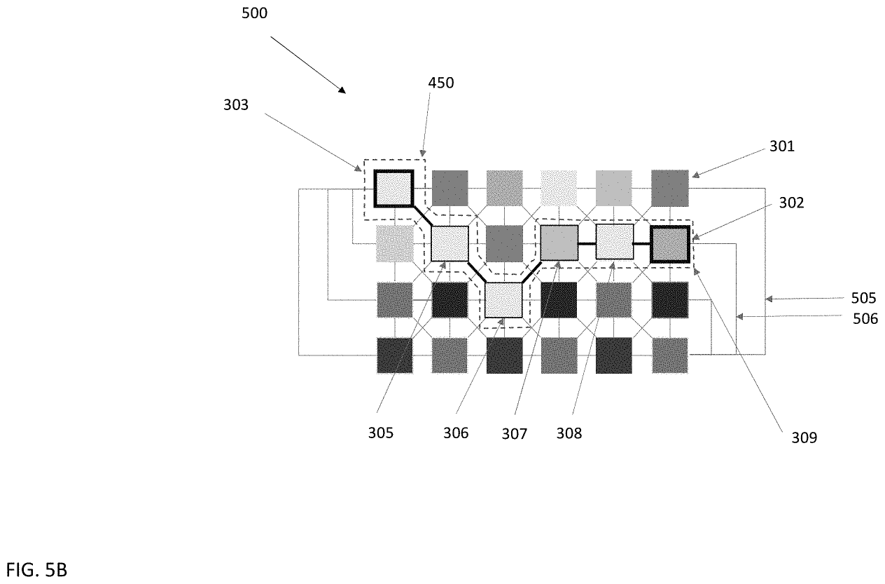

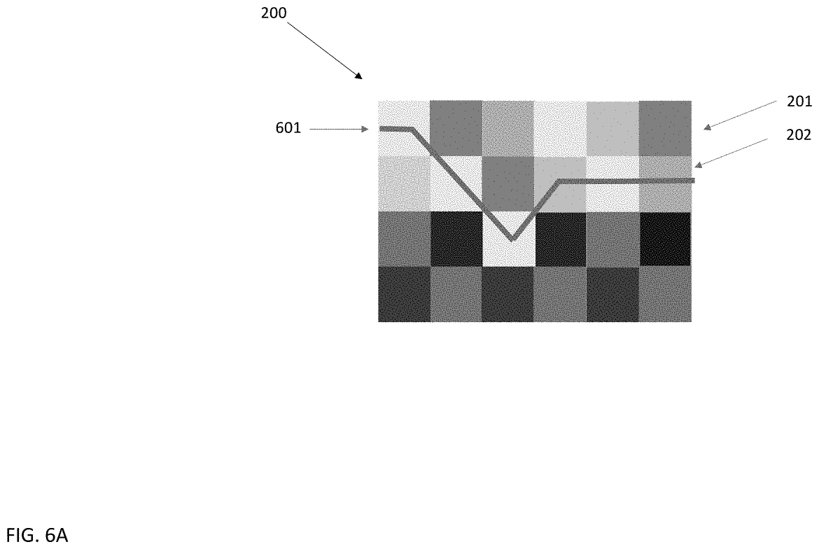

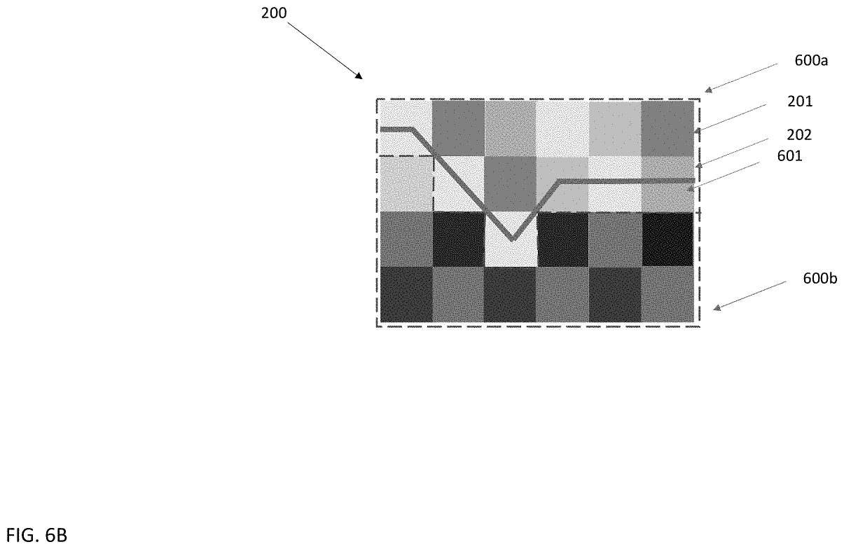

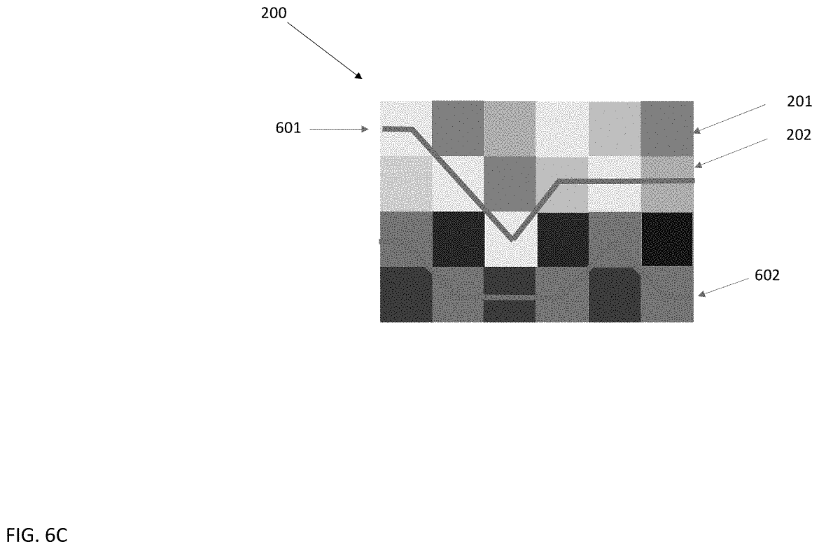

FIG. 6A is the image 200 with a path 601 traversing a portion of the image 200, according to some embodiments. In some embodiments, one or more processors described herein can be configured to generate a version of image 200 that shows path 601 in response to determining and/or selecting the path 601 using a graph (e.g., graph 300, 400, or 500) from image 200. In some embodiments, path 601 can indicate the location of one or more retina fundus features in image 200, such as a boundary between a first layer of a subject's retina fundus and a second layer of the subject's retina fundus. In some embodiments, the processor(s) may be configured to determine and/or select multiple paths and generate a version of image 200 showing each path. For example, the various paths can correspond to features of a subject's retina fundus shown in the image 200.

FIG. 6B is the image 200 with first and second subsets 600a and 600b of pixels indicated in the image 200, according to some embodiments. In some embodiments, one or more processors described herein can be configured to divide image 200 into a plurality of subsets of pixels, such as subsets 600a and 600b shown in FIG. 6B. For example, one or each subset of pixels 600A and/or 600B may include pixels corresponding to one or more retina fundus features. In FIG. 6B, first subset 600a is shown with the path 601 traversing pixels of the subset 600a, which may correspond to a first feature of a person's retina fundus shown in image 200. In some embodiments, at least some pixels of second subset 600B may correspond to a second feature of the person's retina fundus. The inventors recognized that dividing pixels of an image into subsets prior to locating at least some features in the image can facilitate locating features in different areas of the image.

In some embodiments, the processor(s) can be configured to divide pixels of image 200 into subsets 600a and 600b after locating the feature of image 200 indicated by path 601. For example, the processor(s) can be configured to sort the pixels traversed by path 601 into subset 600a together with pixels that are contiguous with the traversed pixels on one side of path 601. In this example, the processor(s) can be configured to sort the pixels on the other side of path 601 into subset 600b. In this example, since a first feature may have been located in subset 600a by processing the whole image 200 to obtain path 601, dividing the image between subsets 600a and 600b can focus further processing of image 200 in subset 600b to locate additional features.

Alternatively or additionally, in some embodiments, the processor(s) can be configured to divide pixels of image 200 into subsets 600a and 600b based on characteristics of the pixels such as pixel intensity, frequency, and/or phase. For example, the processor(s) may be configured to sort, into each subset, contiguous pixels having above a threshold pixel intensity level and/or that are within a threshold pixel intensity level of one another. In this example, dividing the image into subsets of pixels based on pixel characteristics can facilitate locating features in expected locations relative to one another (e.g., locating adjacent retinal layer boundaries in a retina fundus image) and/or distinguishing features located in different subsets based on the relative characteristics (e.g., relative pixel intensity) of the subsets. For instance, the processor(s) can be configured to apply one or more vector quantization techniques (e.g., KMeans clustering) to obtain a plurality of clusters and select the cluster having a higher (or lower) cluster mean (e.g., corresponding to pixel intensity values), at which point the processor(s) can be configured to apply a polynomial fit to locate one or more features (e.g., the Retinal Pigment Epithelium and/or Retinal Nerve Fiber Layer) in the selected cluster.

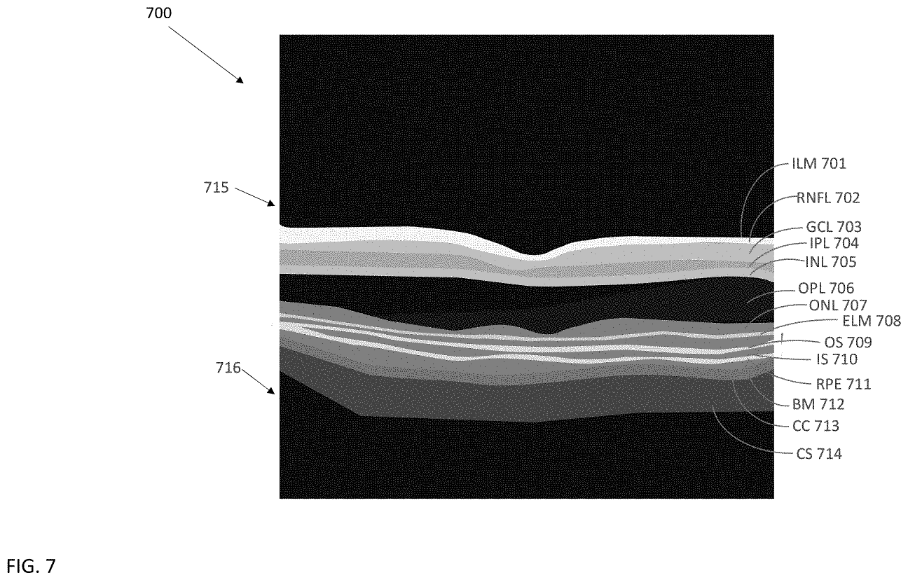

FIG. 6C is the example image 200 with a second indicated path 602 further traversing a portion of the image 200, according to some embodiments. For example, second path 602 can correspond to a second feature located using graph generation and path determination techniques described herein for path 601. In this example, the processor(s) may be configured to generate a graph using the pixels of subset 600b to determine second path 602. FIG. 7 is an example image 700 of a subject's retina fundus, according to some embodiments. In some embodiments, the image 700 may be captured using imaging devices described herein (e.g., imaging device 132).

In some embodiments, the image 700 can show one or more features of the subject's retina fundus. For example, in FIG. 7, image 700 shows layers 701-714 of the subject's retina fundus, as well as a region of vitreous fluid 715 adjacent layer 701 and the subject's sclera 716 adjacent layer 714. In some embodiments, layer 701 may be the subject's Internal Limiting Membrane (ILM) layer, layer 702 may be the subject's Retinal Nerve Fiber Layer (RNFL), layer 703 may be the subject's Ganglion Cell Layer (GCL), layer 704 may be the subject's Inner Plexiform Layer (IPL), layer 705 may be the subject's Inner Nuclear Layer (INL), layer 706 may be the subject's Outer Plexiform Layer (OPL), layer 707 may be the subject's Outer Nuclear Layer (ONL), layer 708 may be the subject's External Limiting Membrane (ELM) layer, layer 709 may be the outer segment (OS) of the subject's Photoreceptor (PR) layers, layer 710 may be the inner segment (IS) of the subject's PR layers, layer 711 may be the subject's Retinal Pigment Epithelium (RPE) layer, layer 712 may be the subject's Bruch's Membrane (BM) layer, layer 713 may be the subject's Choriocapillaris (CC) layer, and/or layer 714 may be the subject's Choroidal Stroma (CS) layer. It should be appreciated that image 700 may show any or each layer of the subject's retina fundus according to various embodiments.

In some embodiments, one or more processors described herein may be configured to locate one or more features of the subject's retina fundus shown in image 700. For example, the processor(s) can be configured to generate a graph from image 700 as described herein for graph 300, graph 400, and/or graph 500 and determine one or more paths traversing the graph (e.g., path 450). In this example, the processor(s) can be configured to select one or more paths and generate a version of image 700 showing the path(s) traversing the image 700, which can indicate the location(s) of the feature(s). In the example of FIG. 7, the processor(s) can be configured to locate features such as any or each of layers 701-714 and/or boundaries between any or each of layers 701-716.

In some embodiments one or more processors described herein can be configured to generate a derivative of the image 700 and generate a graph using the derivative of the image 700.

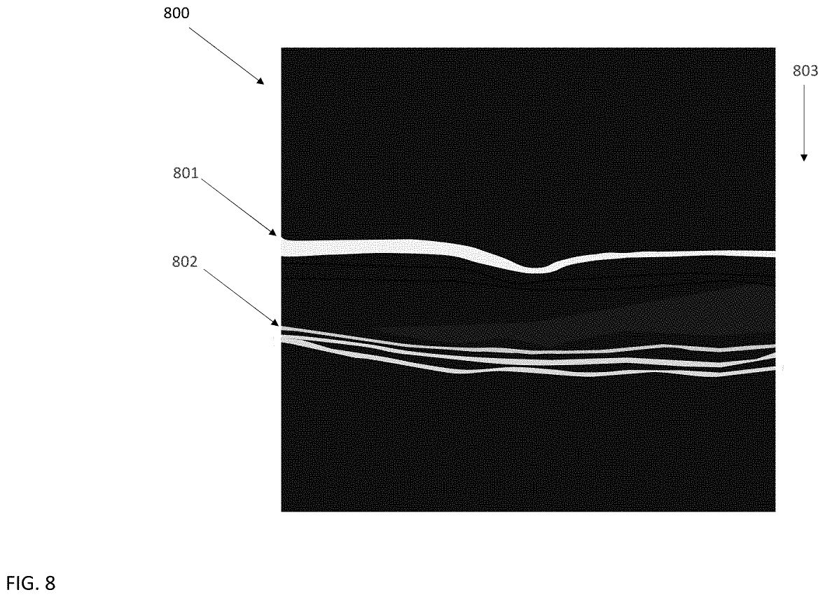

FIG. 8 is an example derivative image 800 that may be generated using the image 700, according to some embodiments. In some embodiments, one or more processors described herein can be configured to generate derivative image 800 using image 700. For example, the processor(s) can be configured to generate the derivative image 800 by applying a filter to the image 700. For example, the filter may be configured to output, for some or each pixel of image 700, a derivative of pixel intensity of image 700 at the respective pixel. In the example of FIG. 8, derivative image 800 is a positive derivative image, as the pixel intensity of pixels of image 800 indicates portions where, in the direction 803, the pixel intensity of corresponding pixels of image 700 are increasing. In some embodiments, the processor(s) may be configured to generate the derivative image 800 using a convolutional filter, such as using Sobel, Laplacian, Prewitt, and Roberts operators. In some embodiments, the processor(s) may be configured to generate a graph from the derivative image 800.

The inventors have recognized that a derivative of an image of a subject's retina fundus may emphasize the location of certain features of the subject's retina fundus in the image. For example, in derivative image 800, portions 801 and 802 of derivative image 800, which can correspond to layers 701 and 708 shown in image 700, have higher pixel intensity values than in the image 700. In some embodiments, the processor(s) may be configured to generate a graph from a positive derivative image such as derivative image 800 and determine one or more paths traversing the graph to locate, in image 700, the boundary between the subject's ILM and the region of vitreous fluid adjacent the ILM, and/or the IS-OS boundary. For example, portions of the retina fundus image between the ILM layer and vitreous fluid region and/or the IS-OS boundary may be more prominent in the derivative image than in the retina fundus image. In some embodiments, the processor(s) can be configured to alternatively or additionally generate a negative derivative image of the image 700 and generate a graph from the negative derivative image and determine one or more paths traversing the graph, such as to locate the BM layer in the image 700. For example, a negative derivative image of a retina fundus image may make the BM layer more prominent.

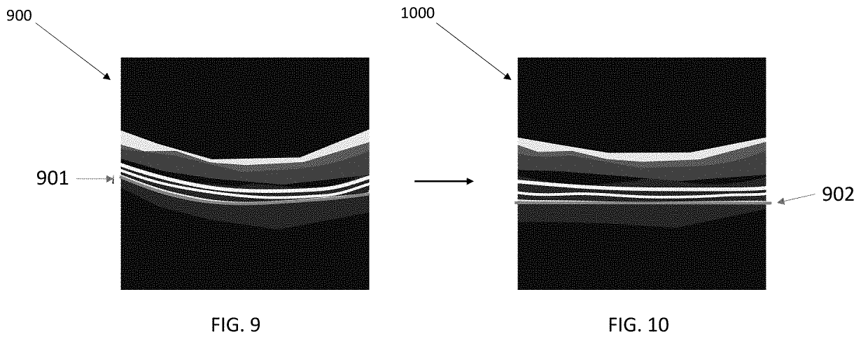

FIG. 9 is another example image 900 of a subject's retina fundus, according to some embodiments. In some embodiments, image 900 (e.g., an OCT image) can show one or more features of the subject's retina fundus. In some embodiments, one or more processors described herein may be configured to locate one or more retina fundus features in image 900, such as using techniques described herein in connection with FIGS. 2-8. In FIG. 9, a curve 901 indicates the location of a feature of the subject's retina fundus. For example, curve 901 can indicate the subject's RPE layer.

In some embodiments one or more processors described herein can be configured to shift pixels of image 900 within columns of image 900 after locating at least one feature in image 900. For example, the processor(s) can be configured to locate the feature indicated by curve 901 and shift pixels within columns of image 900 until curve 901 forms a line across one or more rows of pixels of image 900. The inventors have recognized that shifting pixels of an image after locating a retina fundus feature (e.g., the RPE layer) can better position pixels of the image for feature location.

FIG. 10 is an example image 1000 that may be generated by shifting pixels within columns of the image 900, according to some embodiments. As shown in FIG. 10, pixels within columns of image 1000 are shifted with respect to image 900, such that the pixels showing curve 901 form one or more rows showing a substantially flat line 902. In some embodiments, the processor(s) may be configured to locate one or more features of image 1000 using techniques described herein.

The inventors have also recognized that the foregoing techniques can be combined advantageously to locate retina fundus features in an image. One example process that incorporates multiple foregoing techniques is described herein in connection with FIGS. 11-19.

FIG. 11 is yet another example image 1100 of a subject's retina fundus, according to some embodiments. As shown in FIG. 11, the image 1100 (e.g., an OCT image) can show features 1101-1109 and 1111-1112 of the subject's retina fundus. For example, feature 1101 may be a region of vitreous fluid, feature 1102 may be the subject's ILM, feature 1103 may be the subject's RNFL, feature 1104 may be the subject's GCL, feature 1105 may be the subject's IPL, feature 1106 may be the subject's INL, feature 1107 may be the subject's OPL, feature 1108 may be the subject's ONL, Layer 1109 may be the subject's OS photoreceptor layer, feature 1110 may be the subject's IS photoreceptor layer, feature 1111 may be the subject's RPE, and feature 1112 may be the subject's BM. In some embodiments, pixels of image 1100 as shown in FIG. 11 may have been shifted within columns of image 1100 as described herein in connection with FIGS. 9-10.

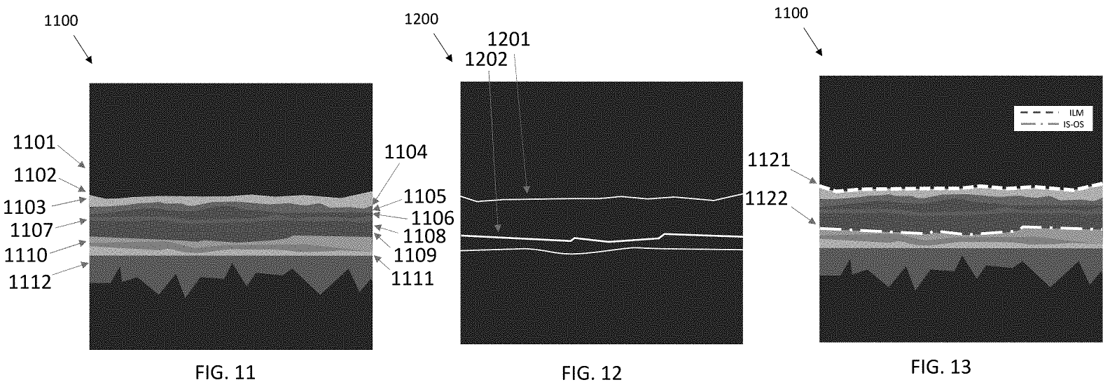

FIG. 12 is a positive derivative image 1200 that may be generated from the image 1100, according to some embodiments. In some embodiments, one or more processors described herein can be configured to generate derivative image 1200 to increase the pixel intensity values of pixels corresponding to boundary 1201 between features 1101 and 1102 (e.g., the ILM-vitreous boundary) and/or boundary 1202 between features 1109 and 1110 (e.g., the IS-OS boundary). In some embodiments, the processor(s) may be configured to generate one or more graphs from the positive derivative image 1200 (e.g., including generating one or more auxiliary nodes) and determine one or more paths traversing the graph to locate boundary 1201 and/or 1202, as described herein including in connection with FIGS. 7-8.

FIG. 13 is the image 1100 with indicated paths 1121 and 1122 traversing boundary 1201 between features 1101 and 1102 and boundary 1202 between features 1109 and 1110, respectively, of the subject's retina fundus, according to some embodiments. In some embodiments, one or more processors described herein can be configured to determine path 1121 and/or 1122 from derivative image 1200 using techniques described herein. For example, the processor(s) can be configured to locate one feature (e.g., boundary 1201), divide pixels of image 1100 and/or derivative image 1200 into subsets of pixels, and locate the other feature (e.g., boundary 1202) in a different subset than the subset containing the first-located feature, as described herein including in connection with FIGS. 6A-6C.

In some embodiments, the processor(s) described herein can be alternatively or additionally configured to generate a negative derivative of image 1100 to locate retina fundus features within image 1100. For example, the processor(s) can be configured to generate the negative derivative image after locating feature 1122 in image 1100, as feature 1122 can be used to divide the negative derivative image to facilitate locating additional features in image 1100.

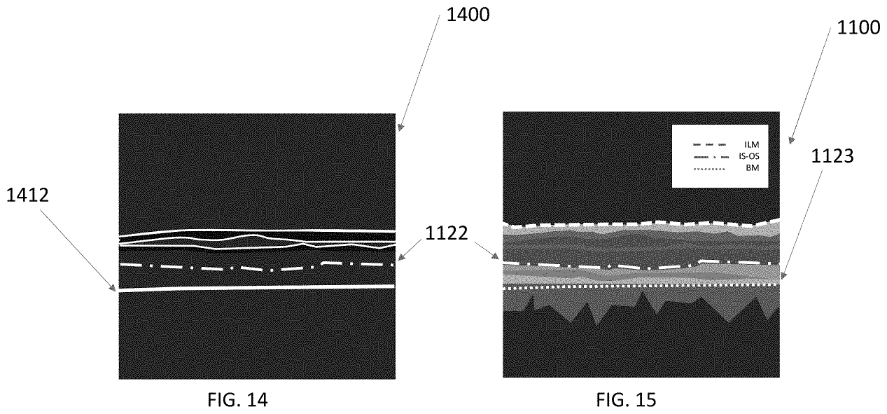

FIG. 14 is a negative derivative image 1400 that may be generated from the image 1100. As shown in FIG. 14, boundary 1412 may have higher (or lower) pixel intensity values than in image 1100. In some embodiments, boundary 1412 may correspond to the boundary between features 1111 and 1112 (e.g., the RPE-BM boundary). In FIG. 14, path 1122 from FIG. 13 indicating boundary 1202 is superimposed over negative derivative image 1400. For example, the processor(s) can be configured to divide pixels of negative derivative image 1400 into subsets of pixels on either side of path 1122. In some embodiments, the processor(s) may be configured to select the subset of pixels on the side of path 1122 that includes boundary 1412 and generate a graph from negative derivative image 1400 and determine one or more paths traversing the graph to locate boundary 1412.

FIG. 15 is the image 1100 with an indicated path 1123 further traversing boundary 1412 of the subject's retina fundus, according to some embodiments.

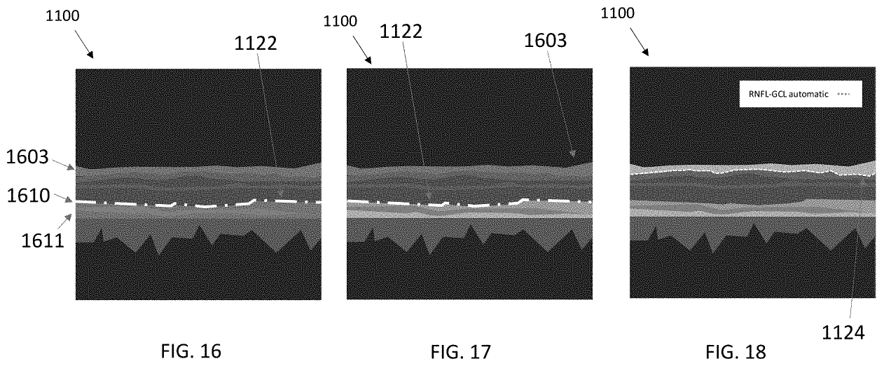

FIG. 16 is the image 1100 further indicating subsets of pixels 1603, 1610, and 1611 having above a threshold pixel intensity level, according to some embodiments. As shown in FIG. 16, pixels of subset 1603 can correspond to feature 1103, pixels of subset 1610 can correspond to feature 1110, and pixels of subset 1611 can correspond to feature 1111. In some embodiments, one or more processors described herein may be configured to identify subset 1603, 1610, and/or 1611 of contiguous pixels as having above a threshold pixel intensity level. In the example of FIG. 16, subsets of pixels other than subsets 1603, 1610, and 1611 can include pixels having a pixel intensity level below the threshold. According to various embodiments, pixels having the threshold pixel intensity level can be grouped with pixels having above the threshold pixel intensity level and/or with pixels having below the threshold pixel intensity level, as embodiments described herein are not so limited.

Also shown in FIG. 16, path 1122 indicating boundary 1202 is superimposed over image 1100. For example, the processor(s) can be configured to further divide subsets 1603, 1610, and 1611 on either side of boundary 1202.

FIG. 17 is the image 1100 indicating one of the subsets 1603 of pixels having above the threshold pixel intensity level in FIG. 16, according to some embodiments. In some embodiments, the processor(s) may be configured to select one or more of the subsets 1603, 1610, and 1611 of contiguous pixels from image 1100 in which to locate a feature of the subject's retina fundus. For example, the processor(s) may be configured to select subset 1603 based as being on the upper (e.g., outer, of the subject's retina fundus in the depth direction) side of boundary 1202. In some embodiments, the processor(s) may be configured to locate feature a boundary between features 1103 and 1104 (e.g., the RNFL-GCL boundary) within selected pixel subset 1603.

FIG. 18 is the image 1100 with an indicated path 1124 traversing the boundary between features 1103 and 1104 of the subject's retina fundus, according to some embodiments. In some embodiments, one or more processors described herein may be configured to determine path 1124 by generating a graph using pixels of subset 1603. Alternatively or additionally, in some embodiments, the processor(s) may be configured to determine path 1124 as a lowermost (e.g., innermost of the retina fundus, in the depth direction in which image 1100 was captured) border of subset 1603.

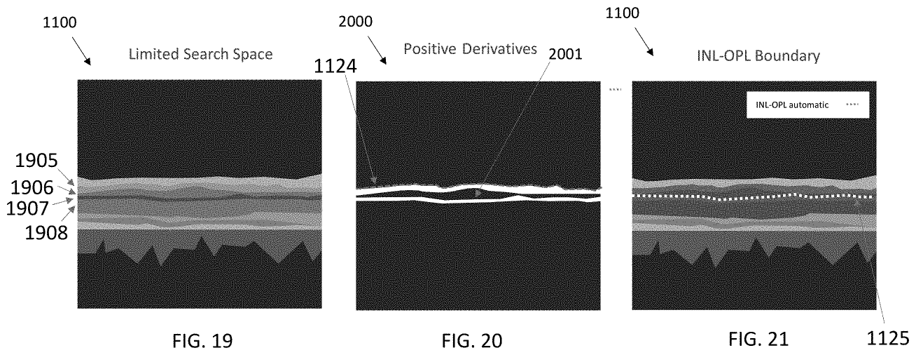

FIG. 19 is the image 1100 indicating subsets of pixels 1905, 1906, 1907, and 1908 having below a threshold pixel intensity threshold, according to some embodiments. In some embodiments, subsets 1905, 1906, 1907, and 1908 may correspond to features 1105, 1106, 1107, and 1108 in FIG. 11. In some embodiments, the processor(s) may be configured to apply the same pixel intensity threshold to obtain subsets 1905, 1906, 1907, and 1908 as to obtain subsets 1603, 1610, and 1611 in FIG. 16. Alternatively or additionally, the processor(s) may be configured to apply a different pixel intensity threshold than to obtain subsets 1603, 1610, and 1611.

FIG. 20 is an example positive derivative image 2000 that may be generated using subsets of pixels 1905, 1906, 1907, and 1908 in image 1100 indicated in FIG. 19, according to some embodiments. The inventors recognized that generating a derivative image using only in one or more selected subsets of pixels of an image can further emphasize portions of the image in the selected subset(s). For example, in FIG. 20, a region 2001 corresponding to features 1105 and 1107 may be further emphasized than in positive derivative image 1200. Also in FIG. 20, path 1124 is shown traversing derivative image 2000. In some embodiments, the processor(s) can be configured to select region 2001 in derivative image 2000 to locate a boundary between features 1106 and 1107 based on path 1124. For example, path 1124 may indicate the location of feature 1105 in derivative image 2000, and the processor(s) may be configured to select region 2001 based on the location of feature 1105.

According to some embodiments, the subset may be a subset of contiguous pixels having above a threshold pixel intensity level and the one or more processors may be configured to determine whether or not a contiguous set of pixels comprises pixels having a pixel intensity level higher than a threshold pixel intensity level.

FIG. 21 is the image 1100 with an indicated path 1125 traversing the boundary between features 1106 and 1107, according to some embodiments.

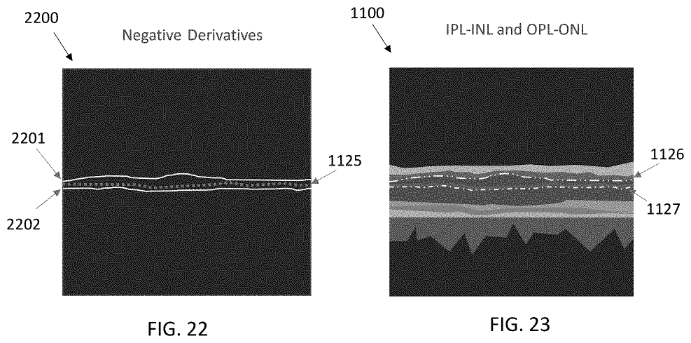

FIG. 22 is an example negative derivative image 2200 that may be generated using subsets of pixels 1905, 1906, 1907, and 1908 in image 1100 indicated in FIG. 19, according to some embodiments. In FIG. 22, boundary 2201 between features 1105 and 1106 (e.g., the IPL-INL boundary) and boundary 2202 between features 1107 and 1108 (e.g., the OPL-ONL boundary) may be further emphasized than in negative derivative image 1400. Also in FIG. 22, path 1125 is shown traversing derivative image 2200. In some embodiments, the processor(s) can be configured to select subsets of pixels of derivative image 2200 on either side of path 1125 for locating boundaries 2201 and 2202 in the respective selected subsets.

FIG. 23 is the image 1100 with indicated paths 1126 and 1127 traversing boundary 2201 between features 1105 and 1106 and boundary 2202 between features 1107 and 1108, according to some embodiments.

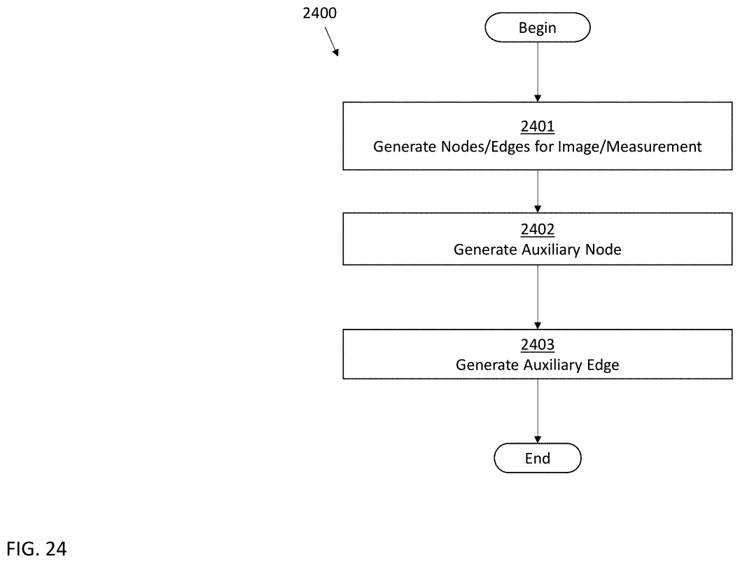

FIG. 24 is a flowchart of an example method 2400 of generating a graph from an image and/or measurement, according to some embodiments. In some embodiments, method 2400 may be performed using one or more processors of systems described herein (e.g., system 100), and/or a non-transitory storage medium can have instructions stored there on that, when executed by one or more processors, cause the processor(s) to execute method 2400.

In FIG. 24, method 2400 is shown including generating nodes and/or edges of the graph corresponding to pixels of the image and/or measurement at step 2401, generating an auxiliary node of the graph at step 2402, and generating an auxiliary edge connecting the auxiliary node to one or more nodes of the graph at step 2403. In some embodiments, the image and/or measurement can be of a subject's retina fundus, such as described herein in connection with FIGS. 7, 9, and 11.

In some embodiments, generating the nodes and/or edges of the graph at step 2401 can include the processor(s) generating nodes for some or all pixels of the image and/or measurement and edges connecting the nodes to one another, such as described herein in connection with FIG. 3. For example, nodes and edges generated at step 2401 can include at least one column of nodes connected to one another by edges. In some embodiments, method 2400 can further include assigning weighted values to some or all of the edges generated at step 2401, as described herein in connection with FIG. 3.

In some embodiments, generating the auxiliary node at step 2402 can include the processor(s) adding the auxiliary node to the nodes corresponding to pixels of the image and/or measurement, such as described herein in connection with FIG. 4A. For example, the auxiliary node may not correspond to any pixels of the image and/or measurement and may be a start or end node of the graph. In some embodiments, step 2402 can include the processor(s) generating a plurality of auxiliary nodes, such as a start node and an end node of the graph.

In some embodiments, generating the auxiliary edge at step 2403 can include the processor(s) connecting the auxiliary node to at least one node of the graph generated at step 2401, such as described herein in connection with FIG. 4A. For example, the processor(s) can connect the auxiliary node to one or more adjacent nodes of the graph, which can include multiple nodes corresponding to pixels within a single column of the image and/or measurement.

In some embodiments, method 2400 may further include locating a boundary between first and second layers of the subject's retina fundus using the graph, such as described herein including in connection with FIGS. 11-23. For example, method 2400 can include determining a plurality of paths traversing the graph (e.g., from an auxiliary node that is the start node to an auxiliary node that is the end node) and selecting a path from among the plurality of paths. In this example, the selected path can correspond to the boundary between the first and second layers of the subject's retina fundus in the image and/or measurement.

In some embodiments, method 2400 can further include shifting pixels within columns of the image and/or measurement prior to generating the graph at step 2401. Alternatively or additionally, pixels of the image and/or measurement used to generate the graph may have previously been shifted within columns of the pixels prior to performing method 2400, as embodiments described herein are not so limited.

In some embodiments, method 2400 can further include generating a derivative (e.g., a positive and/or negative derivative) of the image and/or measurement and generating the graph using the derivative(s), as described herein including in connection with FIGS. 9-10. Alternatively or additionally, the image and/or measurement used to generate the graph may already be a derivative of another image and/or measurement generated prior to performing method 2400, as embodiments described herein are not so limited.

In some embodiments, method 2400 can further include dividing pixels of the image and/or measurement into subsets and selecting a subset of pixels for generating the graph at step 2401 and/or within which to locate a feature (e.g., boundary between layers) of the subject's retina fundus, such as described herein including in connection with FIGS. 16-23.

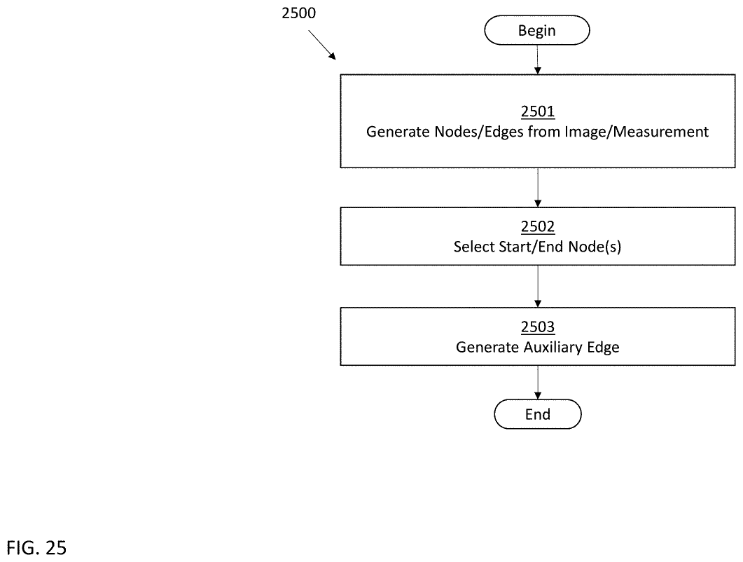

FIG. 25 is a flowchart of an alternative example method 2500 of generating a graph from an image and/or measurement, according to some embodiments. In some embodiments, method 2500 may be performed in the manner described herein for method 2400. For example, method 2500 can be performed using one or more processors described herein and/or a non-transitory storage medium can have instructions stored thereon that, when executed by one or more processors, cause the processor(s) to perform method 2500. Alternatively or additionally, the image and/or measurement can be of a subject's retina fundus.

In FIG. 25, method 2500 is shown including generating nodes and edges of a graph from an image and/or measurement at step 2501, selecting a start and/or end node from the nodes of the graph at step 2502, and generating an auxiliary edge connecting the start or end node to another node of the graph at step 2503.

In some embodiments, generating a graph from the image and/or measurement at step 2501 may be performed in the manner described herein for step 2401 of method 2400.

In some embodiments, selecting the start and/or end node from the nodes of the graph at step 2402 can include the processor(s) selecting a corner node corresponding to a corner pixel of the image and/or measurement as the start and/or end node. In some embodiments, the processor(s) can select a first node corresponding to a first corner pixel in a first column of the image and/or measurement as the start node and a second node corresponding to a second corner pixel in a second column of the image and/or measurement as the end node.

In some embodiments, generating an auxiliary edge connecting the start or end node to another node of the graph at step 2503 can include the processor(s) generating the auxiliary edge connecting the start node to another node corresponding to a pixel in the same column as the pixel corresponding to the start node, such as described herein in connection with FIG. 5A. Alternatively or additionally, as described herein in connection with FIG. 5A, the processor(s) can generate an auxiliary edge connecting the end node to another node corresponding to a pixel in the same column as the pixel corresponding to the end node. For example, the processor(s) can generate one or more auxiliary edges connecting the start node to some or all nodes corresponding to pixels in the same column as the pixel corresponding to the start node and/or one or more auxiliary edges connecting the end node to some or all nodes corresponding to pixels in the same column as the pixel corresponding to the end node.

In some embodiments, method 2500 can further include assigning weighted values to some or all edges generated at step 2501 and/or assigning a preset weighted value to the auxiliary edge(s) generated at step 2503, such as described herein in connection with FIGS. 5A-5B. In some embodiments, method 2500 can further include locating a feature of the subject's retina fundus in the image and/or measurement, such as by determining and/or selecting one or more paths traversing nodes of the graph, as described herein in connection with FIG. 5B.

In some embodiments, method 2500 can further include other steps of method 2400 described herein in connection with FIG. 24.

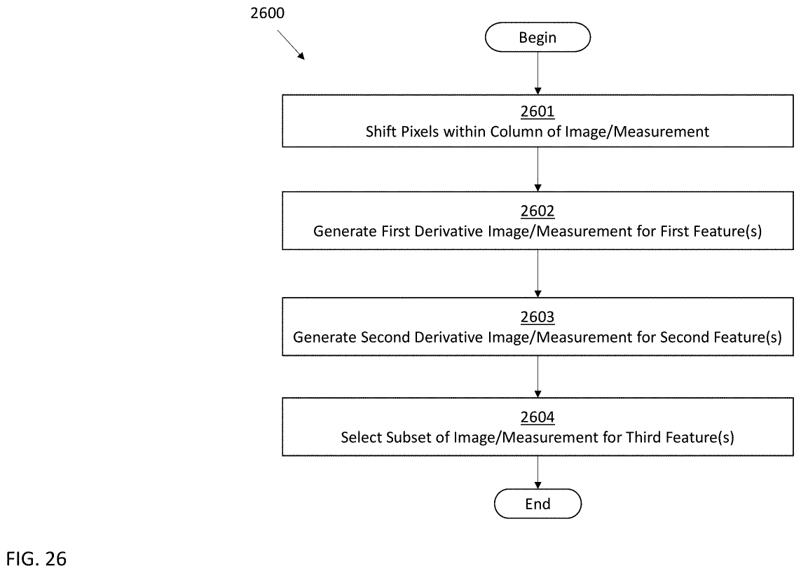

FIG. 26 is an example method 2600 of locating one or more features of a subject's retina fundus in an image and/or measurement of the subject's retina fundus, according to some embodiments. In some embodiments, method 2600 can be performed using one or more processors described herein, and/or a non-transitory computer readable medium may have instructions encoded thereon that, when executed by one or more processors, cause the processor(s) to perform method 2600.

As shown in FIG. 26, method 2600 can include shifting pixels within one or more columns of the image and/or measurement at step 2601, generating a first derivative image and/or measurement from the image and/or measurement for locating one or more first features at step 2602, generating a second derivative image and/or measurement from the image and/or measurement for locating one or more second features at step 2603, and selecting a subset of the image and/or measurement for locating one or more third features at step 2604.

In some embodiments, shifting pixels within one or more columns of the image and/or measurement at step 2601 can include the processor(s) shifting the pixels until pixels of the image and/or measurement corresponding to at least one feature of the subject's retina fundus (e.g., the RPE) form a line along one or more rows of the image and/or measurement, as described herein in connection with FIGS. 9-10.

In some embodiments, generating a first derivative image and/or measurement from the image and/or measurement for locating the first feature(s) at step 2602 can include the processor(s) generating a positive and/or negative derivative image as described herein in connection with FIGS. 7-8. For example, the processor(s) can generate a positive derivative image that further emphasizes the first feature(s) (e.g., the ILM-vitreous boundary and/or IS-OS boundary) in the image and/or measurement. In some embodiments, step 2602 can further include locating the first feature(s), such as described herein in connection with method 2400 and/or 2500.

In some embodiments, generating the second derivative image and/or measurement from the image and/or measurement for locating the second feature(s) at step 2603 can include the processor(s) generating a positive and/or negative derivative image as described herein for step 2602. For example, the processor(s) can generate a negative derivative image that further emphasizes the second feature(s) (e.g., the RPE-BM boundary) in the image and/or measurement. In some embodiments, the processor(s) can determine the location of the second feature(s) using the location(s) of the first feature(s) located at step 2602, as described herein in connection with FIGS. 14-15.

In some embodiments, selecting a subset of the image and/or measurement for locating the third feature(s) at step 2604 can include the processor(s) applying a threshold (e.g., pixel intensity threshold) to pixels of the image and/or measurement and selecting one or more subsets of pixels of the image and/or measurement that are above, or below, the threshold, such as described herein in connection with FIG. 16. For example, pixels at the threshold level can be sorted with pixels that are above the threshold level or below the threshold according to various embodiments. In some embodiments, step 2604 can further include locating the third feature(s) (e.g., the RNFL-GCL boundary) in the selected subset(s), such as described herein in connection with FIG. 17. For example, the processor(s) can use the location(s) of the first and/or second feature(s) (e.g., the IS-OS boundary) located at step 2602 and/or 2603 to select a subset of pixels for locating the third feature(s), such as described herein in connection with FIG. 17.

In some embodiments, step 2604 can alternatively or additionally include generating a derivative image and/or measurement of the same or another selected subset(s), in the manner described herein for steps 2602-2603, for locating the third feature(s) (e.g., the INL-OPL, IPL-INL, and/or OPL-ONL), such as described herein in connection with FIGS. 19-23.

In some embodiments, method 2600 can further include some or all steps of method 2400 and/or 2500 described in connection with FIGS. 24-25.

IV. Applications

The inventors have developed improved imaging and measuring techniques that may be implemented using imaging apparatuses described herein. According to various embodiments, such imaging and measuring techniques may be used for processing an image.

The inventors have recognized that various health conditions may be indicated by the appearance of a person's retina fundus in one or more images captured according to techniques described herein. For example, diabetic retinopathy may be indicated by tiny bulges or micro-aneurysms protruding from the vessel walls of the smaller blood vessels, sometimes leaking fluid and blood into the retina. In addition, larger retinal vessels can begin to dilate and become irregular in diameter. Nerve fibers in the retina may begin to swell. Sometimes, the central part of the retina (macula) begins to swell, such as macular edema. Damaged blood vessels may close off, causing the growth of new, abnormal blood vessels in the retina. Glaucomatous optic neuropathy, or Glaucoma, may be indicated by thinning of the parapapillary retinal nerve fiber layer (RNFL) and optic disc cupping as a result of axonal and secondary retinal ganglion cell loss. The RNFL layer may be measured, for example, as averages in different eye sectors around the optic nerve head. The inventors have recognized that RNFL defects, for example indicated by OCT, are one of the earliest signs of glaucoma. In addition, age-related macular degeneration (AMD) may be indicated by the macula peeling and/or lifting, disturbances of macular pigmentation such as yellowish material under the pigment epithelial layer in the central retinal zone, and/or drusen such as macular drusen, peripheral drusen, and/or granular pattern drusen. AMD may also be indicated by geographic atrophy, such as a sharply delineated round area of hyperpigmentation, nummular atrophy, and/or subretinal fluid.

Stargardt's disease may be indicated by death of photoreceptor cells in the central portion of the retina. Macular edema may be indicated by a trench in an area surrounding the fovea. A macular hole may be indicated by a hole in the macula. Diabetic macular edema (DME) may be indicated by fluid accumulation in the retina due to damaged vessel leakage. Eye floaters may be indicated by non-focused optical path obscuring. Retinal detachment may be indicated by severe optic disc disruption, and/or separation from the underlying pigment epithelium. Retinal degeneration may be indicated by the deterioration of the retina. Age-related macular degeneration (AMD) may be indicated by a thinning of the retina overall, in particular the RPE layer. Wet AMD may also lead to leakage in the retina. Central serous retinopathy (CSR) may be indicated by an elevation of sensory retina in the macula, and/or localized detachment from the pigment epithelium. Choroidal melanoma may be indicated by a malignant tumor derived from pigment cells initiated in the choroid. Cataracts may be indicated by opaque lens, and may also cause blurring fluorescence lifetimes and/or 2D retina fundus images. Macular telangiectasia may be indicated by a ring of fluorescence lifetimes increasing dramatically for the macula, and by smaller blood vessels degrading in and around the fovea. Alzheimer's disease and Parkinson's disease may be indicated by thinning of the RNFL. It should be appreciated that diabetic retinopathy, glaucoma, and other such conditions may lead to blindness or severe visual impairment if not properly screened and treated. In another example, optic neuropathy, optic atrophy and/or choroidal folding can be indicated in images captured using techniques described herein. Optic neuropathy and/or optic atrophy may be caused by damage within the eye, such as glaucoma, optic neuritis, and/or papilledema, damage along the path of the optic nerve to the brain, such as a tumor, neurodegenerative disorder, and/or trauma, and/or congenital conditions such as Leber's hereditary optic atrophy (LHOA) autosomal dominant optic atrophy (ADOA). For example, compressive optic atrophy may be indicated by and/or associated with such extrinsic signs as pituitary adenoma, intracranial meningioma, aneurysms, craniopharyngioma, mucoceles, papilloma, and/or metastasis, and/or such extrinsic signs as optic nerve glioma, optic nerve sheath (ONS) meningioma, and/or lymphoma. Optic atrophy may be indicated by macular thinning with preserved foveal thickness. Vascular and/or ischemic optic atrophy be indicated by and/or associated with sector disc pallor, non-arteritic anterior ischemic optic neuropathy (NAION), arteritic ischemic optic neuropathy (AION), severe optic atrophy with gliosis, giant cell arteritis, central retinal artery occlusion (CRAO), carotid artery occlusion, and/or diabetes. Neoplastic optic atrophy may be indicated by and/or associated with lymphoma, leukemia, tumor, and/or glioma Inflammatory optic atrophy may be indicated by sarcoid, systemic lupus erythematosus (SLE), Behcet's disease, demyelination, such as multiple-sclerosis (MS) and/or neuromyelitis optica spectrum disorder (NMOSD) also known as Devic disease, allergic angiitis (AN), and/or Churg-Strauss syndrome. Infectious optic atrophy may be indicated by the presence of a viral, bacterial, and/or fungal infection. Radiation optic neuropathy may also be indicated.

Moreover, in some embodiments, an imaging apparatus may be configured to detect a concussion at least in part by tracking the movement of a person's eye(s) over a sequence of images. For example, iris sensors, white light imaging components, and/or other imaging components described herein may be configured to track the movement of the person's eyes for various indications of a concussion. Toxic optic atrophy and/or nutritional optic atrophy may be indicated in association with ethambutol, amiodarone, methanol, vitamin B12 deficiency, and/or thyroid ophthalmopathy. Metabolic optic atrophy may be indicated by and/or associated with diabetes. Genetic optic atrophy may be indicated by and/or associated with ADOA and/or LHOA. Traumatic optic neuropathy may be indicated by and/or associated with trauma to the optic nerve, ONS hematoma, and/or a fracture.

Accordingly, in some embodiments, a person's predisposition to various medical conditions may be determined based on one or more images of the person's retina fundus captured according to techniques described herein. For example, if one or more of the above described signs of a particular medical condition (e.g., macula peeling and/or lifting for AMD) is detected in the captured image(s), the person may be predisposed to that medical condition.

The inventors have also recognized that some health conditions may be detected using fluorescence imaging techniques described herein. For example, macular holes may be detected using an excitation light wavelength between 340-500 nm to excite retinal pigment epithelium (RPE) and/or macular pigment in the subject's eye having a fluorescence emission wavelength of 540 nm and/or between 430-460 nm. Fluorescence from RPE may be primarily due to lipofuscin from RPE lysomes. Retinal artery occlusion may be detected using an excitation light wavelength of 445 nm to excite Flavin adenine dinucleotides (FAD), RPE, and/or nicotinamide adenine dinucleotide (NADH) in the subject's eye having a fluorescence emission wavelength between 520-570 nm. AMD in the drusen may be detected using an excitation light wavelength between 340-500 nm to excite RPE in the subject's eye having a fluorescence emission wavelength of 540 nm and/or between 430-460 nm. AMD including geographic atrophy may be detected using an excitation light wavelength of 445 nm to excite RPE and elastin in the subject's eye having a fluorescence emission wavelength between 520-570 nm. AMD of the neovascular variety may be detected by exciting the subject's choroid and/or inner retina layers. Diabetic retinopathy may be detected using an excitation light wavelength of 448 nm to excite FAD in the subject's eye having a fluorescence emission wavelength between 590-560 nm. Central serous chorio-retinopathy (CSCR) may be detected using an excitation light wavelength of 445 nm to excite RPE and elastin in the subject's eye having a fluorescence emission wavelength between 520-570 nm. Stargardt's disease may be detected using an excitation light wavelength between 340-500 nm to excite RPE in the subject's eye having a fluorescence emission wavelength of 540 nm and/or between 430-460 nm. Choroideremia may be detected using an excitation light wavelength between 340-500 nm to excite RPE in the subject's eye having a fluorescence emission wavelength of 540 nm and/or between 430-460 nm.

The inventors have also developed techniques for using a captured image of a person's retina fundus to diagnose various health issues of the person. For example, in some embodiments, any of the health conditions described above may be diagnosed.

In some embodiments, imaging techniques described herein may be used for health status determination, which may include determinations relating to cardiac health, cardiovascular disease and/or cardiovascular risk, anemia, retinal toxicity, body mass index, water weight, hydration status, muscle mass, age, smoking habits, blood oxygen levels, heart rate, white blood cell counts, red blood cell counts, and/or other such health attributes. For example, in some embodiments, a light source having a bandwidth of at least 40 nm may be configured with sufficient imaging resolution capturing red blood cells having a diameter of 6 μm and white blood cells having diameters of at least 15 μm. Accordingly, imaging techniques described herein may be configured to facilitate sorting and counting of red and white blood cells, estimating the density of each within the blood, and/or other such determinations.

In some embodiments, imaging techniques described herein may facilitate tracking of the movement of blood cells to measure blood flow rates. In some embodiments, imaging techniques described herein may facilitate tracking the width of the blood vessels, which can provide an estimate of blood pressure changes and profusion. For example, an imaging apparatus as described herein configured to resolve red and white blood cells using a 2-dimensional (2D) spatial scan completed within 1 μs may be configured to capture movement of blood cells at 1 meter per second. In some embodiments, light sources that may be included in apparatuses described herein, such as super-luminescent diodes, LEDs, and/or lasers, may be configured to emit sub-microsecond light pulses such that an image may be captured in less than one microsecond. Using spectral scan techniques described herein, an entire cross section of a scanned line (e.g., in the lateral direction) versus depth can be captured in a sub-microsecond. In some embodiments, a 2-dimensional (2D) sensor described herein may be configured to capture such images for internal or external reading at a slow rate and subsequent analysis. In some embodiments, a 3D sensor may be used. Embodiments described below overcome the challenges of obtaining multiple high quality scans within a single microsecond.

In some embodiments, imaging apparatuses described herein may be configured to scan a line aligned along a blood vessel direction. For example, the scan may be rotated and positioned after identifying a blood vessel configuration of the subject's retina fundus and selecting a larger vessel for observation. In some embodiments, a blood vessel that is small and only allows one cell to transit the vessel in sequence may be selected such that the selected vessel fits within a single scan line. In some embodiments, limiting the target imaging area to a smaller section of the subject's eye may reduce the collection area for the imaging sensor. In some embodiments, using a portion of the imaging sensor facilitates increasing the imaging frame rate to 10 s of KHz. In some embodiments, imaging apparatuses described herein may be configured to perform a fast scan over a small area of the subject's eye while reducing spectral spread interference. For example, each scanned line may use a different section of the imaging sensor array. Accordingly, multiple depth scans may be captured at the same time, where each scan is captured by a respective portion of the imaging sensor array. In some embodiments, each scan may be magnified to result in wider spacing on the imaging sensor array, such as wider than the dispersed spectrum, so that each depth scan may be measured independently.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments can be implemented in any of numerous ways. One or more aspects and embodiments of the present disclosure involving the performance of processes or methods may utilize program instructions executable by a device (e.g., a computer, a processor, or other device) to perform, or control performance of, the processes or methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above. The computer readable medium or media can be transportable, such that the program or programs stored thereon can be loaded onto one or more different computers or other processors to implement various ones of the aspects described above. In some embodiments, computer readable media may be non-transitory media.

The terms “image” and “measurement” as used herein in the specification and in the claims, unless clearly indicated to the contrary should be understood to mean an image and/or measurement, i.e., an image and a measurement, an image, or a measurement. The terms “images” and “measurements” may also be understood to mean images and/or measurements.

The above-described embodiments can be implemented in any of numerous ways. One or more aspects and embodiments of the present disclosure involving the performance of processes or methods may utilize program instructions executable by a device (e.g., a computer, a processor, or other device) to perform, or control performance of, the processes or methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above. The computer readable medium or media can be transportable, such that the program or programs stored thereon can be loaded onto one or more different computers or other processors to implement various ones of the aspects described above. In some embodiments, computer readable media may be non-transitory media.

The terms “program” or “software” are used herein in a generic sense to refer to any type of computer code or set of computer-executable instructions that can be employed to program a computer or other processor to implement various aspects as described above. Additionally, it should be appreciated that according to one aspect, one or more computer programs that when executed perform methods of the present disclosure need not reside on a single computer or processor, but may be distributed in a modular fashion among a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The acts performed as part of the methods may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

What is claimed is:

1. A method comprising:
generating a graph from an image and/or measurement of a subject's retina fundus, wherein generating the graph comprises generating, by at least one processor:
a plurality of nodes corresponding to a plurality of pixels of the image and/or measurement and a plurality of edges connecting the plurality of nodes;
at least one auxiliary node; and
an auxiliary edge connecting the auxiliary node to a first node of the plurality of nodes.

2. The method of claim 1, wherein:
the auxiliary edge is a first auxiliary edge;
generating the graph further comprises, by the at least one processor, generating a second auxiliary edge connecting the at least one auxiliary node to a second node of the plurality of nodes; and
the first and second nodes correspond to respective first and second pixels in a first column of the image and/or measurement.

3. The method of claim 1, wherein the at least one auxiliary node comprises a first auxiliary node, which is a start node of the graph, and a second auxiliary node, which is an end node of the graph.

4. The method of claim 3, wherein:
the auxiliary edge is a first auxiliary edge and the first node corresponds to a first pixel of the plurality of pixels in a first column of the image and/or measurement;
generating the graph further comprises, by the at least one processor, generating:
a second auxiliary edge connecting the first auxiliary node to a second node of the plurality of nodes corresponding to a second pixel of the plurality of pixels in the first column;
a third auxiliary edge connecting the second auxiliary node to a third node of the plurality of nodes corresponding to a third pixel of the plurality of pixels in a second column of the image and/or measurement; and
a fourth auxiliary edge connecting the second auxiliary node to a fourth node of the plurality of nodes corresponding to a fourth pixel of the plurality of pixels in the second column.

5. The method of claim 1, further comprising locating, by the at least one processor, a boundary between first and second layers of the subject's retina fundus in the image and/or measurement using the graph.

6. The method of claim 5, wherein:
the at least one auxiliary node comprises a start node and/or an end node of the graph; and
locating the boundary comprises determining a plurality of paths from the start node to the at least one auxiliary node and/or from the at least one auxiliary node to the end node and selecting a path from among the plurality of paths.

7. The method of claim 6, wherein:
generating the graph further comprises assigning, to at least some of the plurality of nodes and/or edges, weighted values;
generating the auxiliary edge comprises assigning, to the auxiliary node and/or edge, a preset weighted value; and
selecting the path from among the plurality of paths comprises executing a cost function using the weighted values and the preset weighted value and determining that the path has and/or shares a lowest cost among the plurality of paths.

8. The method of claim 1, further comprising:
prior to generating the graph, shifting one or more pixels of the image and/or measurement with respect to one another, wherein the one or more pixels correspond to a feature of the image and/or measurement.

9. The method of claim 1, wherein the image and/or measurement comprises a plurality of pixels arranged in rows and columns, the method further comprising:
prior to generating the graph, modifying the image and/or measurement, the modifying comprising:
identifying pixels of the plurality of pixels that correspond to a feature of the image and/or measurement; and
shifting one or more pixels of the identified pixels such that the identified pixels are positioned along a same row or a same column of the image and/or measurement.

10. The method of claim 9, wherein the feature of the image and/or measurement comprises a boundary between first and second layers of the subject's retina fundus.

11. A method comprising:
generating a graph from an image and/or measurement of a subject's retina fundus, wherein generating the graph comprises, by at least one processor:
generating a plurality of nodes corresponding to a plurality of pixels of the image and/or measurement and a plurality of edges connecting the plurality of nodes;
selecting a start node and/or an end node of the graph from the plurality of nodes; and
generating, connecting the start and/or end node to a first node of the plurality of nodes, at least one auxiliary edge.

12. The method of claim 11, further comprising, by the at least one processor, assigning weighted values to at least some of the plurality of nodes and/or plurality of edges and assigning a preset weighted value to the at least one auxiliary edge and/or start node and/or end node.

13. The method of claim 12, wherein the weighted values are assigned to the plurality of nodes based on derivatives corresponding to the plurality of nodes and/or assigned to the plurality of edges based on derivatives of pixels that correspond to pairs of the plurality of nodes connected by the plurality of edges.

14. The method of claim 13, wherein generating the at least one auxiliary edge comprises:
generating a first plurality of auxiliary edges connecting the start node to respective ones of a first plurality of perimeter nodes of the plurality of nodes that correspond to pixels of a first column of pixels of the image and/or measurement; and
generating a second plurality of auxiliary edges connecting the end node to respective ones of a second plurality of perimeter nodes of the plurality of nodes correspond to pixels of a second column of pixels of the image and/or measurement.

15. The method of claim 12, further comprising locating, by the at least one processor, a boundary between first and second layers of the subject's retina fundus in the image and/or measurement using the graph.

16. The method of claim 15, wherein locating the boundary comprises determining a plurality of paths from the start node to the end node via the auxiliary edge and selecting a path from among the plurality of paths.

17. The method of claim 16, wherein selecting the path comprises executing a cost function based on the weighted values and the preset weighted value and determining that the path has and/or shares a lowest cost among the plurality of paths.

18. The method of claim 11, further comprising:
prior to generating the graph, shifting one or more pixels of the image and/or measurement with respect to one another, wherein the one or more pixels correspond to a feature of the image and/or measurement.

19. The method of claim 11, wherein the image and/or measurement comprises a plurality of pixels arranged in rows and columns, the method further comprising:
prior to generating the graph, modifying the image and/or measurement, the modifying comprising:
identifying pixels of the plurality of pixels that correspond to a feature of the image and/or measurement; and
shifting one or more pixels of the identified pixels such that the identified pixels are positioned along a same row or a same column of the image and/or measurement.

20. The method of claim 19, wherein the feature of the image and/or measurement comprises a boundary between first and second layers of the subject's retina fundus.
